(19) United States
(12) Patent Application Publication
(10) Pub. No.: US 2007/0030548 A1
(43) Pub. Date: Feb. 8, 2007

(54) Apparatus for generating pulse-modulated signal

(76) Inventors: Yasuhiro Nihei, Kanagawa (JP); Masaaki Ishida, Kanagawa (JP); Atsufumi Omori, Kanagawa (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/494,528

(22) Filed: Jul. 28, 2006

(30) Foreign Application Priority Data
Aug. 2, 2005 (JP) 2005-223939

(51) Int. Cl. G02B 26/08

(52) U.S. Cl. 359/204

(57) ABSTRACT

An apparatus for generating a pulse modulated signal having pulses corresponding to binary values of pixels of image data includes a modulation-data generating unit configured to generate modulation data in response to pixel control data and the image data, the modulation data including a predetermined number of bits for a pixel of the image data, wherein consecutive bits having bit positions responsive to the pixel control data in a line of the predetermined number of bits have a value responsive to a binary value of the pixel, and a modulated-signal generating unit configured to generate a pulse modulated signal in response to the modulation data.

### BACKGROUND OF THE INVENTION

1. Field of the Invention

The present invention generally relates to pixel-clock and pulse-modulated-signal generating apparatuses, optical scan apparatuses, and image forming apparatuses, and particularly to a pixel-clock and pulse-modulated-signal generating apparatus, optical scan apparatus, and image forming apparatus that control dot positions with high precision.

2. Description of the Related Art

FIG. 28 is a drawing showing the configuration of an image drawing system of an image forming apparatus such as a laser printer, digital copier, or the like that has been widely used in recent years.

The image drawing system includes an image processing unit 101, a laser drive circuit 102, a clock generating circuit 103, a phase synchronizing circuit 104, a semiconductor laser 105, a polygon mirror 106, a scan lens 107, a photo detector 108, and a photoconductive body 109.

The optical beam emitted by the semiconductor laser 105 is scanned by the rotating polygon mirror 106, and passes through the scan lens 107 to form an optical spot on the photoconductive body 109 serving as a scanned medium. The exposure of the photoconductive body 109 to light results in the creation of an electrostatic latent image.

The photo detector 108 detects the scanned optical beam, and supplies the detection signal to the phase synchronizing circuit 104. The phase synchronizing circuit 104 generates an image clock based on the detection signal, and supplies the image clock to the image processing unit 101 and the laser drive circuit 102. The image processing unit 101 supplies image data to the laser drive circuit 102.

The laser drive circuit 102 generates a drive signal for controlling the semiconductor laser 105 in accordance with the image data generated by the image processing unit 101 and the image clock having its phase adjusted for each line by the phase synchronizing circuit 104.

In such an image drawing system, a variation in the distance from the rotation axis of deflecting reflective surfaces of a deflector such as the polygon mirror 106 ends up generating variation in the scan speed of an optical spot (optical beam) scanned on the photoconductive body 109. This variation in scan speed causes variation in dot position and image fluctuation, thereby degrading the quality of formed images. Accordingly, there is a need to correct the scan variation in order to achieve high image quality.

Further, in the image drawing system using multi-beams emitted from multiple light sources, a difference in the oscillating wavelengths of the multiple light sources causes a variation in the position of light exposure unless the chromatic aberration of the scan lens is corrected. This results in the width of scan of the optical spot varying depending on the light source, and also results in the position of the dot varying depending on the light source, thereby degrading image quality. Accordingly, there is a need to correct the scan width.

In order to obviate the problems as described above, the following measures are known.

Patent Document 1 and Patent Document 2 disclose a variable-frequency pixel clock and raster-output scan system in which the frequency of the pixel clock is changed to control the position of the optical spot along the scan line. In this technology, the frequency of the pixel clock is changed to correct the variations of dot position, scan speed, and scan width, thereby suppressing degradation in image quality.

[Patent Document 1] Japanese Patent Application Publication No. 2001-228415

[Patent Document 2] Japanese Patent Application Publication No. 11-167081

The variable-frequency method that changes the frequency of the pixel clock as disclosed in Patent Document 1 and Patent Document 2 has a problem in that the configuration of the optical-clock controlling unit becomes complex. The smaller the pitch of frequency modulation, the more complex the configuration of the pixel-clock controlling unit is. This makes it difficult to perform a diligent control of dot position.

Accordingly, there is a need for a pixel-clock and pulse-modulated-signal generating apparatus, optical scan apparatus, and image forming apparatus that can control optical-spot positions (dot positions) with high precision by use of a simple configuration.

### SUMMARY OF THE INVENTION

It is a general object of the present invention to provide an apparatus that substantially obviates one or more problems caused by the limitations and disadvantages of the related art.

Features and advantages of the present invention will be presented in the description which follows, and in part will become apparent from the description and the accompanying drawings, or may be learned by practice of the invention according to the teachings provided in the description. Objects as well as other features and advantages of the present invention will be realized and attained by an apparatus particularly pointed out in the specification in such full, clear, concise, and exact terms as to enable a person having ordinary skill in the art to practice the invention.

To achieve these and other advantages in accordance with the purpose of the invention, the invention provides an apparatus for generating a pulse modulated signal having pulses corresponding to binary values of pixels of image data. The apparatus includes a modulation-data generating unit configured to generate modulation data in response to pixel control data and the image data, the modulation data including a predetermined number of bits for a pixel of the image data, wherein consecutive bits having bit positions responsive to the pixel control data in a line of the predetermined number of bits have a value responsive to a binary value of the pixel, and a modulated-signal generating unit configured to generate a pulse modulated signal in response to the modulation data.

According to at least one embodiment of the present invention, the modulation data includes a predetermined number of bits for a pixel, and the consecutive bits having a value responsive to a binary value of the pixel have bit positions in a line of the predetermined number of bits such that the bit positions are responsive to the pixel control data. Since the pulse-modulated signal is generated in response to the modulation data, the timing of dot printing can be displaced to perform the fine adjustment and control of dot positions.

### BRIEF DESCRIPTION OF THE DRAWINGS

Other objects and further features of the present invention will be apparent from the following detailed description when read in conjunction with the accompanying drawings, in which:

FIG. 1 is a drawing showing the configuration of an image drawing system that includes a pixel-clock and pulse-modulated-signal generating apparatus;

FIG. 2 is a drawing for explaining high-frequency clocks VCLK;

FIG. 3 is a drawing for explaining a pixel clock whose phase is synchronized with a horizontal synchronizing signal;

FIG. 4 is a drawing for explaining a pixel clock generated based on a high-frequency clock and phase data;

FIG. 5 is a drawing for explaining modulation data;

FIG. 6 is a drawing for explaining a PM signal;

FIG. 7 is a drawing showing the configuration of a modulation data generating unit;

FIG. 8 is a drawing showing a data table containing black-pixel data held by a black-pixel-data holding unit;

FIG. 9 is a drawing for explaining the generation of a PM signal (1);

FIG. 10 is a drawing for explaining the generation of a PM signal (2);

FIG. 11 is a drawing for explaining the generation of a PM signal (3);

FIG. 12 is a drawing for explaining the generation of a PM signal (4);

FIG. 13 is a drawing for explaining the generation of a PM signal (5);

FIG. 14 is a drawing for explaining a black-pixel-data selecting unit;

FIG. 15 is a drawing showing black-pixel data selected by a black-pixel-data selecting unit;

FIG. 16 is a drawing showing the configuration of a modulation data generating unit according to a second embodiment;

FIG. 17 is a drawing showing a data table containing black-pixel data held by a black-pixel-data holding unit;

FIG. 18 is a drawing showing a data table containing additional black-pixel data held by an additional black-pixel-data holding unit;

FIG. 19 is a drawing for explaining the generation of a PM signal (6);

FIG. 20 is a drawing for explaining the generation of a PM signal (7);

FIG. 21 is a drawing for explaining the generation of a PM signal (8);

FIG. 22 is a drawing for explaining the generation of a PM signal (9);

FIG. 23 is a drawing for explaining the generation of a PM signal (10);

FIGS. 24A and 24B are drawings for explaining a black-pixel-data selecting unit and an additional-black-pixel-data selecting unit;

FIG. 25 is a drawing showing additional black-pixel data selected by the additional black-pixel-data selecting unit;

FIG. 26 is a drawing showing an optical scan apparatus;

FIG. 27 is a drawing showing an image forming apparatus; and

FIG. 28 is a drawing showing the configuration of an image drawing system of a conventional image forming apparatus.

### DESCRIPTION OF THE PREFERRED EMBODIMENTS

In the following, embodiments of the present invention will be described with reference to the accompanying drawings.

### First Embodiment

A first embodiment of a pixel-clock and pulse-modulated-signal generating apparatus according to the present invention will be described.

<Image Drawing System>

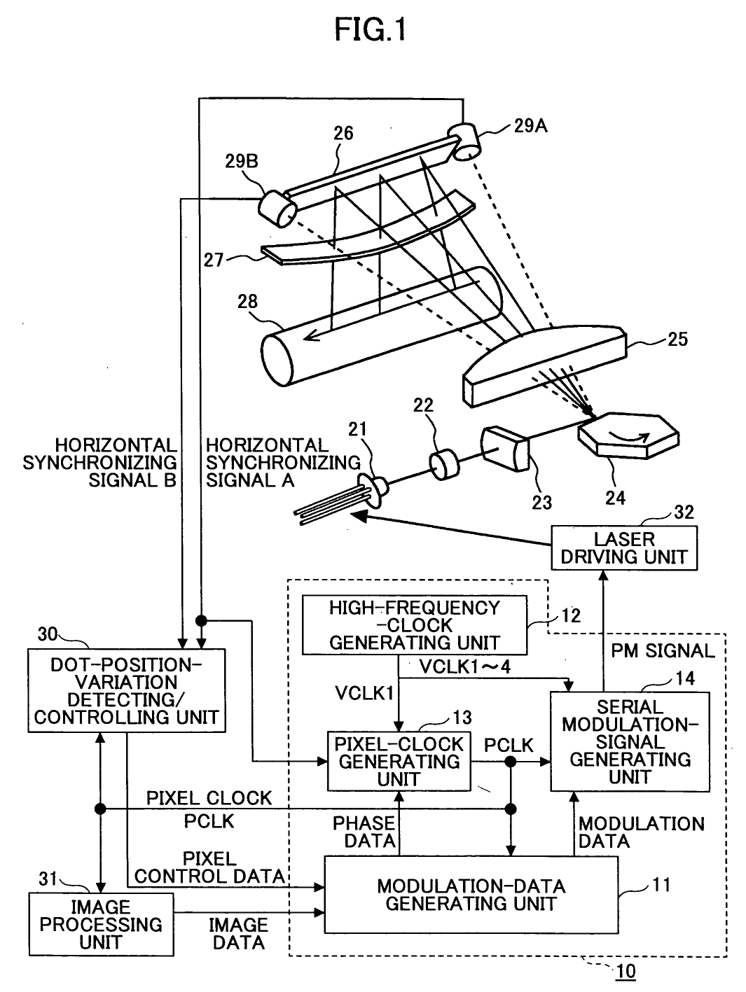

Referring to FIG. 1, a description will be given of the configuration of an image drawing system that includes the first embodiment of the pixel-clock and pulse-modulated-signal generating apparatus.

The image drawing system includes a pixel-clock and pulse-modulated-signal generating apparatus 10, a semiconductor laser 21, a collimator lens 22, a cylinder lens 23, a polygon mirror 24, an fθ lens 25, a mirror 26, a toroidal lens 27, a photoconductive body 28, photo detectors 29A and 29B, a dot-position-variation detecting/controlling unit 30, an image processing unit 31, a laser driving unit 32. The configuration of the pixel-clock and pulse-modulated-signal generating apparatus 10 will later be described.

The optical beam (laser beam) emitted by the semiconductor laser 21 passes through the collimator lens 22 and the cylinder lens 23 to be deflected and scanned by the rotating polygon mirror 24. The deflected and scanned optical beam passes through the fθ lens 25 to be reflected by the mirror 26 to pass through the toroidal lens 27 to reach the photoconductive body 28, thereby forming an electrostatic latent image on the scanned surface of the photoconductive body 28.

The head end and tail end of the mirror 26 are provided with the photo detectors 29A (head end) and 29B (tail end), which detect the scanned optical beam. The photo detector 29A outputs a head-end-side horizontal synchronizing signal A, and the photo detector 29B outputs a tail-end-side horizontal synchronizing signal B.

The dot-position-variation detecting/controlling unit 30 measures a time required for the optical beam to scan based on the horizontal detection signals A and B supplied from the photo detectors 29A and 29B, respectively, and compares the measured time with a reference time to detect the amount of displacement. The dot-position-variation detecting/controlling unit 30 then generates “pixel-control data” for correcting the amount of displacement, and supplies the pixel-control data to a modulation-data generating unit 11 in synchronization with the pixel clock.

The image processing unit 31 generates “image data” by performing image processing on an output image, and supplies the image data to the modulation-data generating unit 11 in synchronization with the pixel clock. The image data is comprised of a set of binary data including white-pixel data representing white and black-pixel data representing black.

The laser driving unit 32 drives the semiconductor laser 21 based on a “PM signal” (pulse modulated signal) supplied from a serial modulated-signal generating unit 14, which will later be described.

<Pixel-Clock and Pulse-Modulated-Signal Generating Apparatus>

The configuration of the pixel-clock and pulse-modulated-signal generating apparatus 10 will now be described. The pixel-clock and pulse-modulated-signal generating apparatus 10 includes the modulation-data generating unit 11, a high-frequency-clock generating unit 12, a pixel-clock generating unit 13, and the serial modulated-signal generating unit 14.

The modulation-data generating unit 11 generates “phase data” and “modulation data” based on the pixel control data supplied from the dot-position-variation detecting/controlling unit 30 and the image data supplied from the image processing unit 31, and outputs the “phase data” and “modulation data” in synchronization with the pixel clock. The phase data is supplied to the pixel-clock generating unit 13, and the modulation data is supplied to the serial modulated-signal generating unit 14.

The configuration of the modulation-data generating unit 11 will later be described.

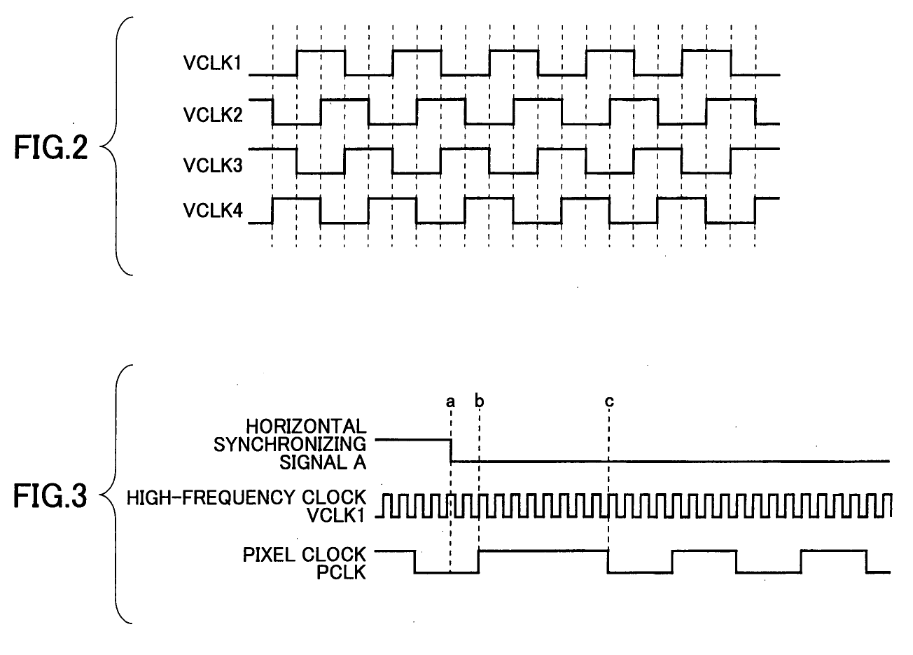

The high-frequency-clock generating unit 12 generates and outputs “high-frequency clocks (VCLK)” for use as a reference for the pixel clock and PM signal. FIG. 2 is a drawing showing the waveforms of the high-frequency clocks. The high-frequency-clock generating unit 12 according to this embodiment generates four high-frequency clocks (VCLK1 through VCLK4) having a phase difference of a 1/4 cycle with the immediately-adjacent-phase clocks, and supplies VCLK1 to the pixel-clock generating unit 13 and VCLK1 through VCLK4 to the serial modulated-signal generating unit 14.

The pixel-clock generating unit 13 generates a “pixel clock (PCLK) changing its cycle on a clock-pulse-by-clock-pulse basis in response to the received high-frequency clock and phase data. The pixel clock is supplied in synchronization with the horizontal synchronizing signal A to the serial modulated-signal generating unit 14, the dot-position-variation detecting/controlling unit 30, the image processing unit 31, and the laser driving unit 32.

In response to the received high-frequency clocks and pixel clock, the serial modulated-signal generating unit 14 converts the parallel “modulation data” supplied from the modulation-data generating unit 11 into a “PM signal” that is a serial pulse modulated signal, which is then supplied to the laser driving unit 32.

<Various Signals and Data>

Various signals and data used in the pixel-clock and pulse-modulated-signal generating apparatus 10 of this embodiment will now be described.

<Pixel Clock>

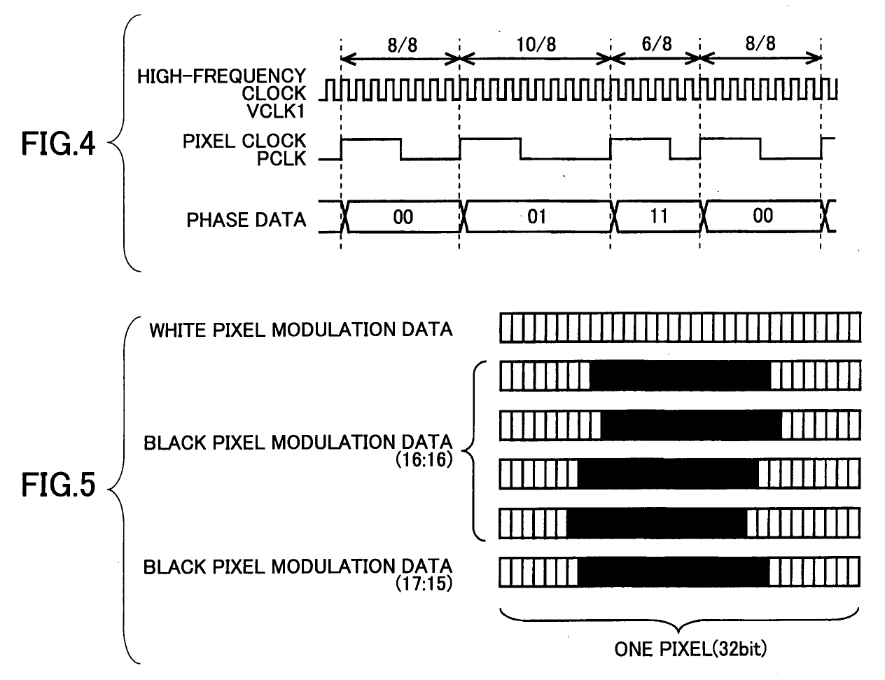

The “pixel clock (PCLK)” will now be described by referring to FIG. 3 and FIG. 4. FIG. 3 is a drawing showing a pixel clock whose phase is synchronized with the horizontal synchronizing signal A. FIG. 4 is a drawing showing a pixel clock generated based on a high-frequency clock and phase data. In this example, what is shown is a clock that has 1/8 of the frequency of the high-frequency clock under the ordinary circumstances (i.e., when the phase data is “00”).

Referring to FIG. 3, a description will now be given of the pixel clock whose phase is synchronized with the horizontal synchronizing signal A. As the horizontal synchronizing signal A falls (“a” in FIG. 3), the pixel clock is temporarily fixed to “H” (“b” in FIG. 3). When the high-frequency clock rises (“c” in FIG. 3) a predetermined number of cycles (i.e., 10 cycles in this example) after the fall of the horizontal synchronizing signal A, the pixel clock becomes “L” so as to restart its clocking.

As described above, the intervals between “a”, “b”, and “c” are constant with the precision corresponding to one cycle of the high-frequency clock, so that the start position of each line can be aligned with high precision.

Referring to FIG. 4, a description will now be given of the pixel clock generated based on a high-frequency clock and phase data. Table 1 given below shows the relationships between the phase data and the phase shift of the pixel clock. A pixel clock prolonged (delayed) by 2/8 of the PCLK cycle in comparison with when the phase data is “00” is output when the phase data is “01”. A pixel clock shortened (advanced) by 2/8 of the PCLK cycle in comparison with when the phase data is “00” is output when the phase data is “11”.

TABLE 1

| Phase Data | Phase Shift |
|---|---|
| 00 | 0 |
| 01 | Elongate by 2/8 of PCLK |
| 11 | Shorten by 2/8 of PCLK |

Receiving the phase data in synchronization with the pixel clock, the pixel-clock generating unit 13 shifts phase in response to the phase data so as to generate the pixel clock having its clock width widened or shortened according to the phase shift. Accordingly, the pixel clock has its cycle varying on a clock-pulse-by-clock-pulse basis in response to the phase data.

<Modulation Data>

“Modulation data” will now be described by referring to FIG. 5. The modulation data is 32 bits in width, and has a data content responsive to the image data (white-pixel data/black-pixel data).

When a corresponding pixel is a white pixel, the modulation data is such that all the 32 bits corresponding to a single pixel are set to “0” indicative of white. When a corresponding pixel is a black pixel, the modulation data is such that 16 consecutive bits of the 32 bits are set to “1” indicative of black, and the 16 remaining bits are set to “0” indicative of white.

In the modulation data corresponding to a black pixel, all the bits for one pixel are not set to black (all the 32 bits are not set to “1”) , but only part of the pixels necessary to create an electrostatic potential for attracting toner to this pixel are set to black. With this configuration, fine adjustment becomes possible such as shifting the black (“1”) of the black pixel by an increment of 1/32 of a pixel (i.e., an increment of 1 bit) or changing the ratio of white to black (e.g., white black=15:17) as shown in FIG. 5.

Shifting of the portion of “1” indicative of black or changing of the ratio of white to black in the modulation data are performed according to parameters defined in the pixel control data. Table 2 shows the relationships between the pixel control data and the shifting. The shifting of the modulation data will later be described.

TABLE 2

| Pixel Control Data | Output Timing |
|---|---|
| 00 | No Shift |
| 01 | Shift to the Right by 1/32 of a pixel |
| 11 | Shift to the left by 1/32 of a pixel |

<PM Signal>

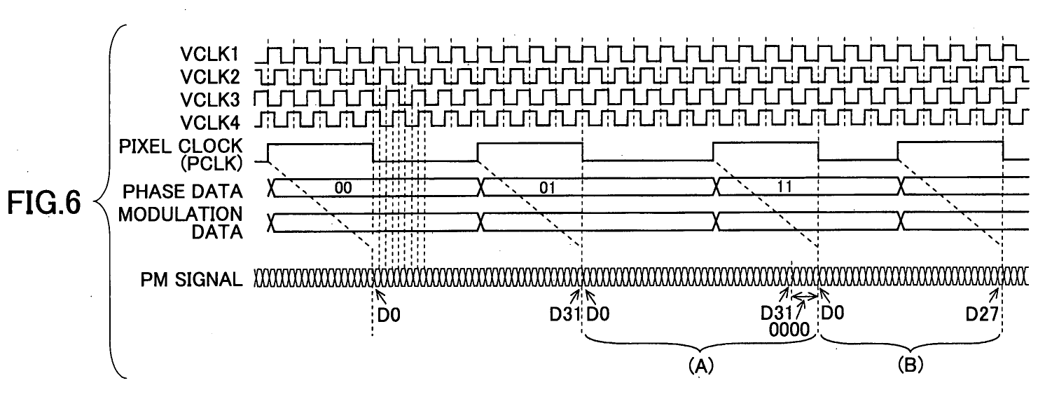

The “PM signal” will now be described by referring to FIG. 6. FIG. 6 is a drawing showing a PM signal generated from various data. In this example, the four clocks (VCLK1 through VCLK4) having phase differences as shown in FIG. 2 are used as high-frequency clocks, and the modulation data having a 32-bit width as shown in FIG. 5 is used as the modulation data.

Data of bit0 of the modulation data is output at the timing of a falling edge of the pixel clock. Thereafter, individual bits of the modulation data are output successively at the rising edges of the high-frequency clocks VCLK1 through VCLK4, and these output bits constitute the PM signal.

When the cycle of the pixel clock is elongated as indicated by (A) in FIG. 6, multiple “0”s that are equal in number to the added length are output following the bit31 of the modulation data. In this example, “0”s for 4 bits are output. When the cycle of the pixel clock is shortened as indicated by (B) in FIG. 6, a corresponding number of bits are discarded. In this example, bit28 through bit31 are discarded, and the PM signal includes the modulation data for the next pixel that immediately follows bit27.

Since the PM signal is made by converting the modulation data based on the high-frequency clocks and the pixel clock, the PM signal has the data contents corresponding to the above-described modulation data. Namely, if the modulation data corresponds to white, the PM signal has all the 32 bits thereof set to “0”. If the modulation data corresponds to black, the PM signal has 16 consecutive bits thereof set to “1” and the remaining bits thereof set to “0”.

As previously described, fine adjustment becomes possible in the present embodiment such as shifting the black (“1”) of the black pixel by an increment of 1/32 of a pixel (i.e., an increment of 1 bit) or changing the ratio of white to black with respect to the modulation data corresponding to a black pixel. Accordingly, the fine adjustment of modulation data allows the PM signal to be also subjected to fine adjustment.

Since the PM signal serves to control the laser driving unit 32, such fine adjustment makes it possible to change the position of black dot printing within one pixel and/or to change the cycle of the pixel clock on a pixel-by-pixel basis to change the timing of dot printing.

<Modulation Data Generating Unit>

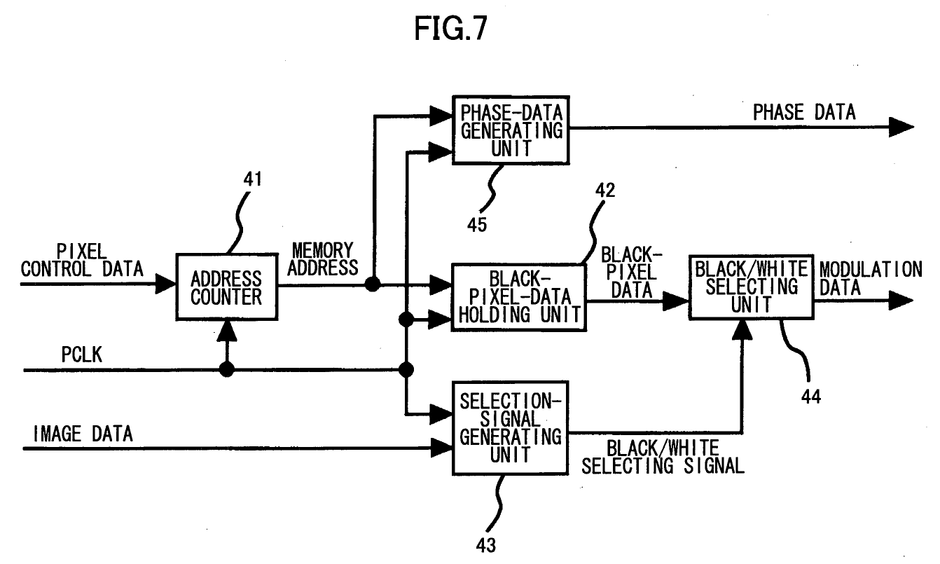

The modulation-data generating unit 11 will now be described by referring to FIG. 7. The modulation-data generating unit 11 includes an address counter 41, a black-pixel-data holding unit 42, a selection-signal generating unit 43, a black/white selecting unit 44, and a phase-data generating unit 45.

The address counter 41 supplies a “memory address” to the black-pixel-data holding unit 42 and the phase-data generating unit 45. The outputting of the memory address is synchronized with the pixel clock.

The address counter 41 changes the value of the memory address in response to the received pixel control data. Specifically, the preceding memory address is kept for output in the case of the pixel control data being “00”, and the memory address is counted up for output from the preceding memory address at the timing of a rising edge of the pixel clock in the case of the pixel control data being “01”. The memory address is counted down for output from the preceding memory address at the timing of a rising edge of the pixel clock in the case of the pixel control data being “11”. Table 3 shows the relationships between the pixel control data and the memory address.

TABLE 3

| Pixel Control Data | Memory Address Value |
|---|---|
| 00 | Maintain Current Address Value |
| 01 | Counting Up at Rising Edge of PCLK |
| 11 | Counting Down at Rising Edge of PCLK |

It should be noted that when the memory address is reset or set to “0” or “16”, the address counter 41 initializes the memory address by setting it to “8”.

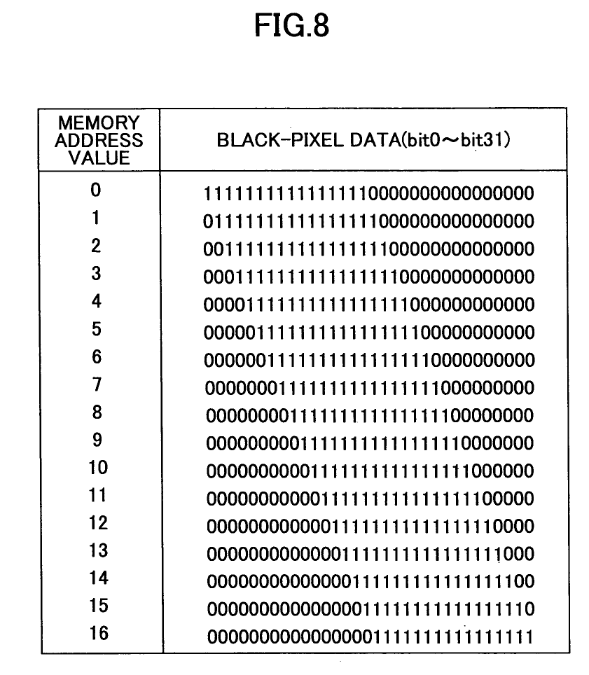

The black-pixel-data holding unit 42 has a data table indicating the relationships between the value of the memory address and the black-pixel data as shown in FIG. 8. In response to the receipt of a memory address, the black-pixel-data holding unit 42 supplies the corresponding black-pixel data to the black/white selecting unit 44.

The selection-signal generating unit 43 supplies to the black/white selecting unit 44 a “black/white selecting signal” that is the image data delayed by one clock by using the pixel clock.

The black/white selecting unit 44 outputs the black-pixel data supplied from the black-pixel-data holding unit 42 as the modulation data if the black/white selecting signal supplied from the selection-signal generating unit 43 is “1”. The black/white selecting unit 44 outputs white-pixel data having all the bits thereof set to “0” (white pixel) as the modulation data if the black/white selecting signal is “0”.

The phase-data generating unit 45 generates and outputs “phase data” in response to the memory address supplied from the address counter 41. Specifically, the phase data “11” is output in the case of the memory address being “0”, and the phase data “01” is output in the case of the memory address being “16”. The phase data “00” is output if the memory address assumes a value other than those described above. Table 4 shows the relationships between the memory address and the generated phase data.

TABLE 4

| Memory Address | Phase Data |
|---|---|
| 0 | 11 |
| 16 | 01 |
| Others | 00 |

<Generation of PM Signal>

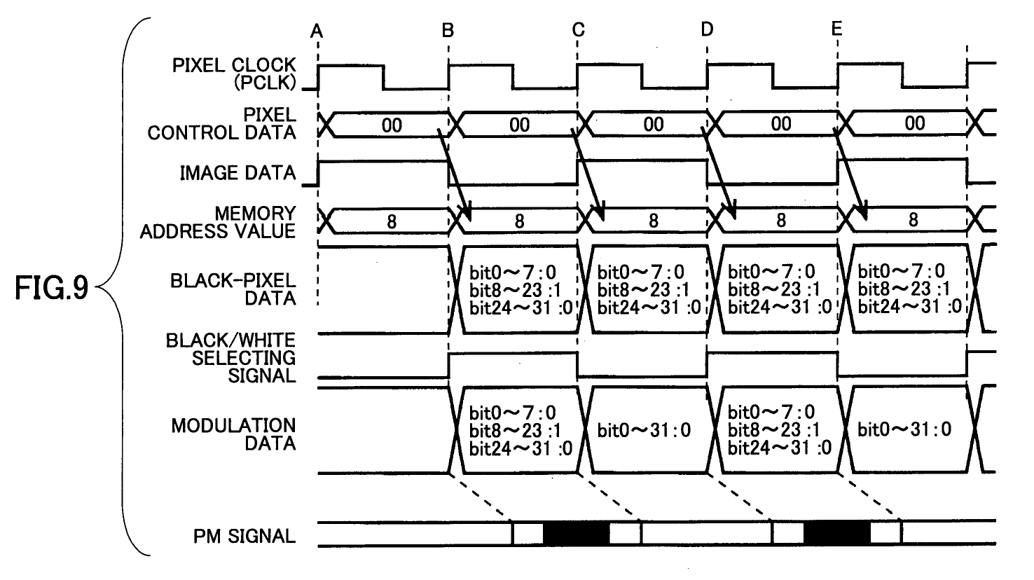

Referring to FIG. 9 through FIG. 14, a description will now be given of the overall operation of the pixel-clock and pulse-modulated-signal generating apparatus 10 of the present embodiment up to the point where the PM signal is generated. In the following disclosure, the term “timing (A through C)” is used to refer to the timing of a rising edge of PCLK.

<Generation of PM Signal (1)>

FIG. 9 is a drawing showing the case in which black-pixel data and white-pixel data are output alternately without displacing the dots. Here, the address counter is set to its initial value “8”.

At timing A, the pixel control data “00” is given. The image data is “1” indicative of a black pixel.

At timing B, the pixel control data “00” is given, so that the address counter 41 keeps the initial value “8” as the memory address (see Table 1), which is then supplied to the black-pixel-data holding unit 42. The black-pixel-data holding unit 42 outputs black-pixel data in which 16 bits “bit8 through bit23” are set to “1” as the black-pixel data corresponding to the memory address “8”.

Since the black/white selecting signal is the image data delayed by one clock by using the pixel clock PCLK, the black/white selecting signal becomes “1” at the timing B. Since the black/white selecting signal is “1”, the black/white selecting unit 44 supplies the black-pixel data provided from the black-pixel-data holding unit 42 to the serial modulated-signal generating unit 14 as the modulation data. The serial modulated-signal generating unit 14 generates the PM signal from the modulation data for serial output.

Since the black/white selecting signal is “0” at timing C (i.e., the image data is “0” at the timing B), the black/white selecting unit 44 supplies the white-pixel data having all the bits thereof set to “0” to the serial modulated-signal generating unit 14 as the modulation data. The serial modulated-signal generating unit 14 generates the PM signal from the modulation data for serial output.

As described above, the pixel-clock and pulse-modulated-signal generating apparatus 10 of the present embodiment has the modulation-data generating unit 11 that generates the modulation data in response to the image data (black pixels/white pixels), thereby being able to generate the PM signal responsive to the received image data.

<Generation of PM Signal (2)>

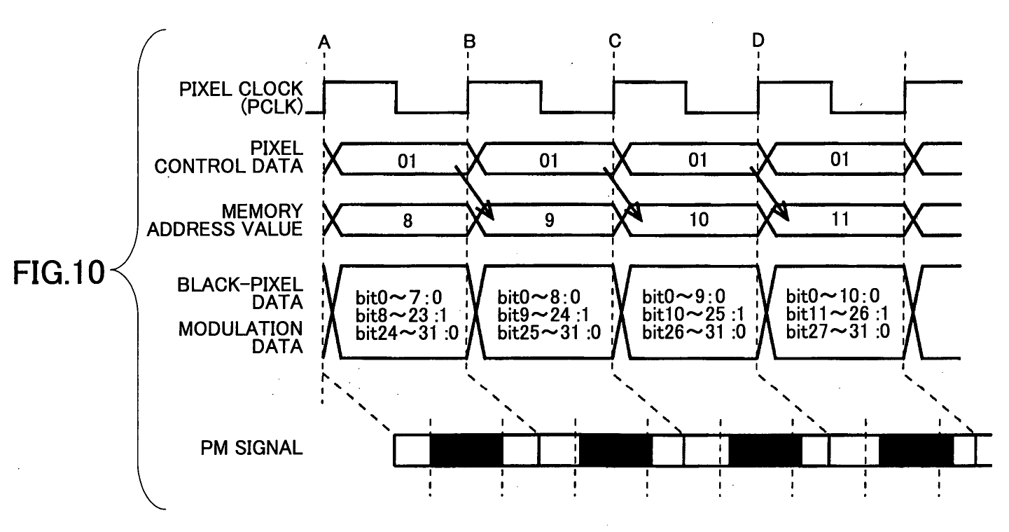

In the following, the operation by which a dot is shifted to the right (displaced to the right) will be described. FIG. 10 is a drawing showing the case in which dots are shifted to the right by 1/32 of a pixel. In the following, the image data is assumed to be all-black-pixel data for the sake of convenience of explanation.

At the timing A, the pixel control data “01” is given. Here, the memory address is set to its initial value “8”. The address counter 41 counts up the memory address at the timing B (see table 3), and supplies “9” as the memory address value to the black-pixel-data holding unit 42.

The black-pixel-data holding unit 42 outputs to, the black/white selecting unit 44, black-pixel data in which 16 bits “bit9 through bit24” are set to “1” as the black-pixel data corresponding to the memory address “9”. The black/white selecting unit 44 supplies this black-pixel data as the modulation data to the serial modulated-signal generating unit 14 (the explanation of black/white selection is omitted since the data is all-black-pixel data in this example). The serial modulated-signal generating unit 14 generates the PM signal from the modulation data for serial output.

In respect of the position of “1” (black bits), the black-pixel data corresponding to the memory address value “8” and the black-pixel data corresponding to the memory address value “9” are displaced by one bit from each other (“9” is shifted to the right) (see FIG. 8). Accordingly, when this black-pixel data is supplied as the modulation data to the serial modulated-signal generating unit 14 to generate the PM signal, the timing at which the black bits are output is delayed by 1/32 of a pixel compared to the immediately preceding pixel (i.e., shifted to the right by 1/32 of a pixel).

The pixel control data is also “01” at timing B, so that the address counter 41 counts up the memory address at the timing C, and supplies “10” as the memory address to the black-pixel-data holding unit 42. The black-pixel-data holding unit 42 outputs to, the black/white selecting unit 44, black-pixel data in which 16 bits “bit10 through bit25” are set to “1” as the black-pixel data corresponding to the memory address “10”. The black/white selecting unit 44 supplies this black-pixel data as the modulation data to the serial modulated-signal generating unit 14. The serial modulated-signal generating unit 14 generates the PM signal from the modulation data for serial output.

Again, in respect of the position of black bits, the black-pixel data corresponding to the memory address value “9” and the black-pixel data corresponding to the memory address value “10” are displaced by one bit from each other (“10” is shifted to the right) (see FIG. 8). Accordingly, when this black-pixel data is supplied as the modulation data to the serial modulated-signal generating unit 14 to generate the PM signal, the timing at which the black bits are output is delayed by 1/32 of a pixel compared to the immediately preceding pixel (i.e., shifted to the right by 1/32 of a pixel).

As described above, the pixel-clock and pulse-modulated-signal generating apparatus 10 of the present embodiment has the modulation-data generating unit 11 that can generate the modulation data in which “1” bits are delayed by an increment of 1/32 of a pixel, thereby being able to delay the generated PM signal by an increment of 1/32 of a pixel. Accordingly, it is possible to delay the timing of dot printing by 1/32 of a pixel, i.e., to shift a dot to the right in units of 1/32 of a pixel.

<Generation of PM Signal (3)>

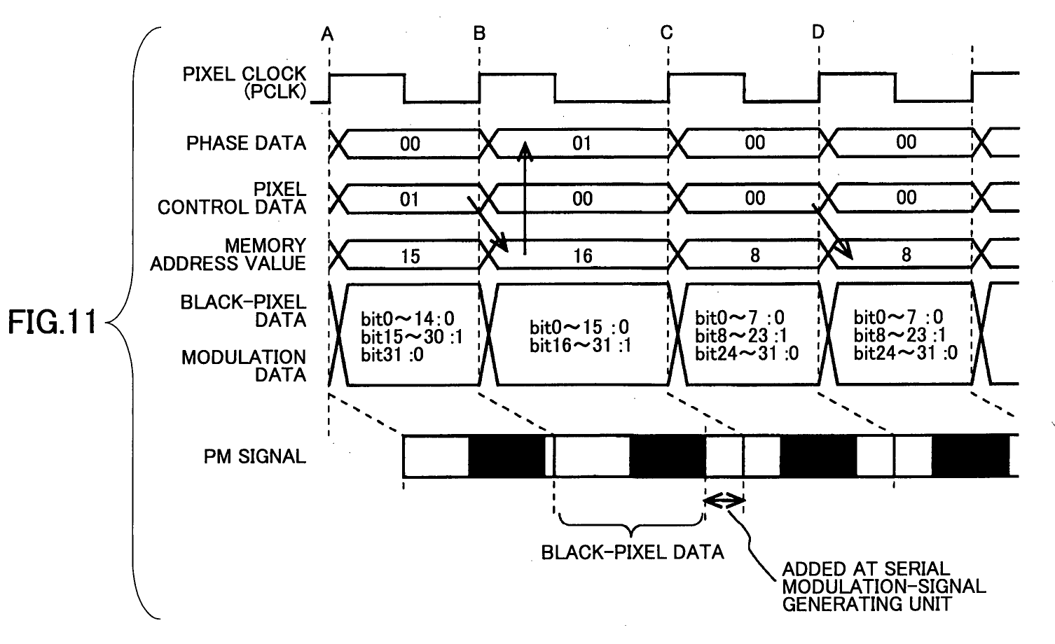

Referring to FIG. 11, a description will now be given of the case in which the memory address value becomes “16” in the generation of the PM signal (2) described above. In the following, the image data is assumed to be all-black-pixel data for the sake of convenience of explanation.

At the timing A, the pixel control data “01” is given. At this timing, the memory address value is “15”. The address counter 41 counts up the memory address at the timing B, and supplies “16” as the memory address value to the black-pixel-data holding unit 42.

The memory address value is also supplied to the phase-data generating unit 45. Upon receiving the memory address value “16”, the phase-data generating unit 45 generates phase data “01” (see Table 4), and supplies the generated phase data to the pixel-clock generating unit 13.

Upon receiving the phase data “01”, the pixel-clock generating unit 13 elongates the pixel clock by 2/8 of a cycle at the timing B, and outputs the elongated pixel clock.

The black-pixel-data holding unit 42 outputs to, the black/white selecting unit 44, black-pixel data in which 16 bits “bit16 through bit31” are set to “1” as the black-pixel data corresponding to the memory address “16”. The black/white selecting unit 44 supplies this black-pixel data as the modulation data to the serial modulated-signal generating unit 14 (the explanation of black/white selection is omitted since the data is all-black-pixel data in this example).

Since the pixel clock is shifted (elongated) at the timing B, the serial modulated-signal generating unit 14 adds “0” data equal in number to 8 bits to generate and output the PM signal.

At the next timing (i.e., timing C), the address counter 41 initializes the memory address value from “16” to “8” to output “8”, and the black-pixel-data holding unit 42 outputs black-pixel data in which 16 bits “bit8 through bit23” are set to “1” as the black-pixel data corresponding to “8”.

As described above, the pixel-clock and pulse-modulated-signal generating apparatus 10 of the present embodiment returns the memory address value to its initial value when the memory address value becomes “16”. Accordingly, even after the memory address value becomes “16”, it is possible to delay the timing of dot printing by 1/32 of a pixel, i.e., to shift a dot to the right in units of 1/32 of a pixel.

<Generation of PM Signal (4)>

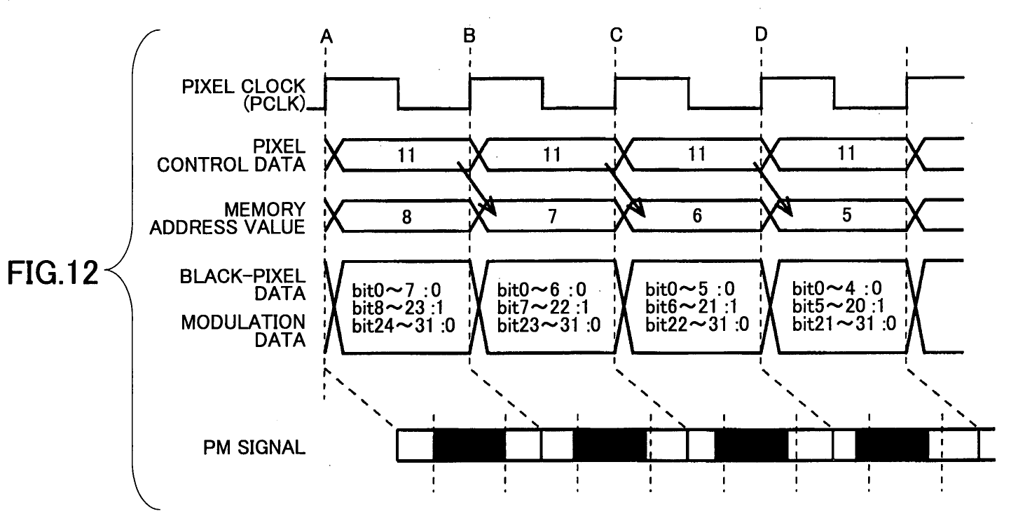

In the following, the operation by which a dot is shifted to the left (displaced to the left) will be described. FIG. 12 is a drawing showing the case in which dots are shifted to the left by 1/32 of a pixel. In the following, the image data is assumed to be all-black-pixel data for the sake of convenience of explanation.

At the timing A, the pixel control data “11” is given. Here, the memory address is set to its initial value “8”. The address counter 41 counts down the memory address at the timing B (see table 3), and supplies “7” as the memory address value to the black-pixel-data holding unit 42.

The black-pixel-data holding unit 42 outputs to, the black/white selecting unit 44, black-pixel data in which 16 bits “bit8 through bit23” are set to “1” as the black-pixel data corresponding to the memory address “7”. The black/white selecting unit 44 supplies this black-pixel data as the modulation data to the serial modulated-signal generating unit 14 (the explanation of black/white selection is omitted since the data is all-black-pixel data in this example). The serial modulated-signal generating unit 14 generates the PM signal from the modulation data for serial output.

In respect of the position of “1” (black bits), the black-pixel data corresponding to the memory address value “8” and the black-pixel data corresponding to the memory address value “7” are displaced by one bit from each other (“7” is shifted to the left) (see FIG. 8). Accordingly, when this black-pixel data is supplied as the modulation data to the serial modulated-signal generating unit 14 to generate the PM signal, the timing at which the black bits are output is advanced by 1/32 of a pixel compared with the immediately preceding pixel (i.e., shifted to the left by 1/32 of a pixel).

The pixel control data is also “11” at timing B, so that the address counter 41 counts down the memory address at the timing C, and supplies “6” as the memory address to the black-pixel-data holding unit 42. The black-pixel-data holding unit 42 outputs to, the black/white selecting unit 44, black-pixel data in which 16 bits “bit7 through bit22” are set to “1” as the black-pixel data corresponding to the memory address “6”. The black/white selecting unit 44 supplies this black-pixel data as the modulation data to the serial modulated-signal generating unit 14. The serial modulated-signal generating unit 14 generates the PM signal from the modulation data for serial output.

Again, in respect of the position of black bits, the black-pixel data corresponding to the memory address value “8” and the black-pixel data corresponding to the memory address value “7” are displaced by one bit from each other (“7” is shifted to the left) (see FIG. 8). Accordingly, when this black-pixel data is supplied as the modulation data to the serial modulated-signal generating unit 14 to generate the PM signal, the timing at which the black bits are output is advanced by 1/32 of a pixel compared with the immediately preceding pixel (i.e., shifted to the left by 1/32 of a pixel).

As described above, the pixel-clock and pulse-modulated-signal generating apparatus 10 of the present embodiment has the modulation-data generating unit 11 that can generate the modulation data in which “1” bits are advanced by an increment of 1/32 of a pixel, thereby being able to advance the generated PM signal by an increment of 1/32 of a pixel. Accordingly, it is possible to advance the timing of dot printing by 1/32 of a pixel, i.e., to shift a dot to the left in units of 1/32 of a pixel.

<Generation of PM Signal (5)>

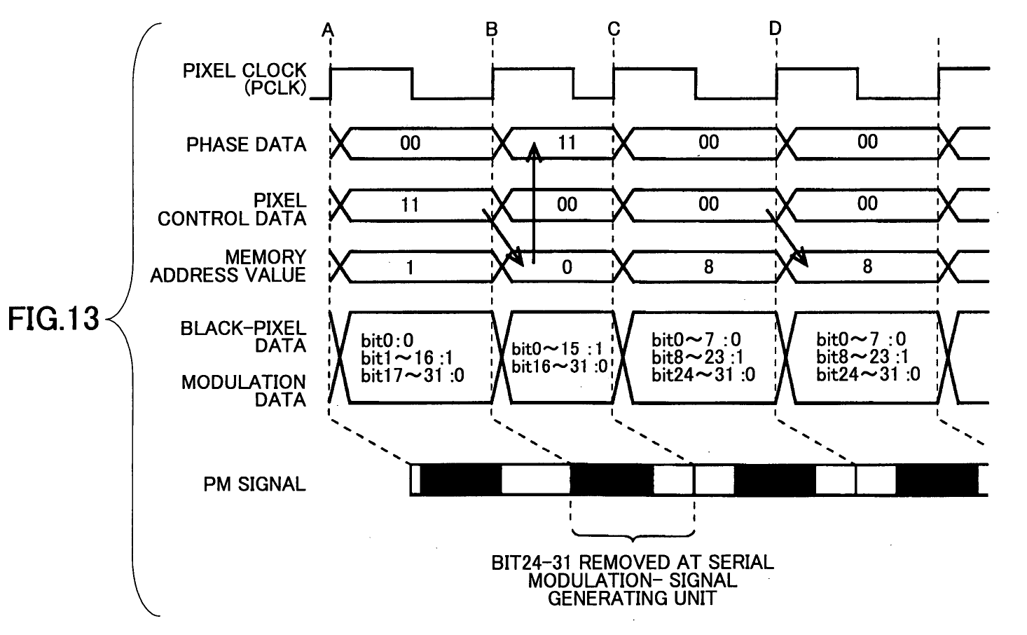

Referring to FIG. 13, a description will now be given of the case in which the memory address value becomes “0” in the generation of the PM signal (4) described above. In the following, the image data is assumed to be all-black-pixel data for the sake of convenience of explanation.

At the timing A, the pixel control data “11” is given. At this timing, the memory address value is “1”. The address counter 41 counts down the memory address at the timing B, and supplies “0” as the memory address value to the black-pixel-data holding unit 42.

The memory address value is also supplied to the phase-data generating unit 45. Upon receiving the memory address value “0”, the phase-data generating unit 45 generates phase data “11” (see Table 4), and supplies the generated phase data to the pixel-clock generating unit 13.

Upon receiving the phase data “11”, the pixel-clock generating unit 13 shortens the pixel clock by 2/8 of a cycle at the timing B, and outputs the shortened pixel clock.

The black-pixel-data holding unit 42 outputs to, the black/white selecting unit 44, black-pixel data in which 16 bits “bit0 through bit15” are set to “1” as the black-pixel data corresponding to the memory address “0”. The black/white selecting unit 44 supplies this black-pixel data as the modulation data to the serial modulated-signal generating unit 14 (the explanation of black/white selection is omitted since the data is all-black-pixel data in this example).

Since the pixel clock is shifted (shortened) at the timing B, the serial modulated-signal generating unit 14 removes 8 bits (bit24 through bit31) (equal in number to 2/8 of a PCLK cycle) to generate and output the PM signal.

At the next timing (i.e., timing C), the address counter 41 initializes the memory address value from “0” to “8” to output “8”, and the black-pixel-data holding unit 42 outputs black-pixel data in which 16 bits “bit8 through bit23” are set to “1” as the black-pixel data-corresponding to “8”.

As described above, the pixel-clock and pulse-modulated-signal generating apparatus 10 of the present embodiment returns the memory address value to its initial value when the memory address value becomes “0”. Accordingly, even after the memory address value becomes “0”, it is possible to advance the timing of dot printing by 1/32 of a pixel, i.e., to shift a dot to the left in units of 1/32 of a pixel.

### Advantage of First Embodiment

As described above, the pixel-clock and pulse-modulated-signal generating apparatus of the present embodiment can displace the PM signal by an increment of 1/32 of a pixel. Accordingly, it is possible to displace the timing of dot printing by an increment of 1/32 of a pixel, thereby performing the fine adjustment and control of dot position. Further, a plurality of high-frequency clocks having respective, different phases are used to change the timing of pixel printing with the precision corresponding to 1/32 of a pixel, which is different from the use of a super-high-frequency clock corresponding to 1/32 of a pixel. This achieves power conservation.

### Variation of First Embodiment

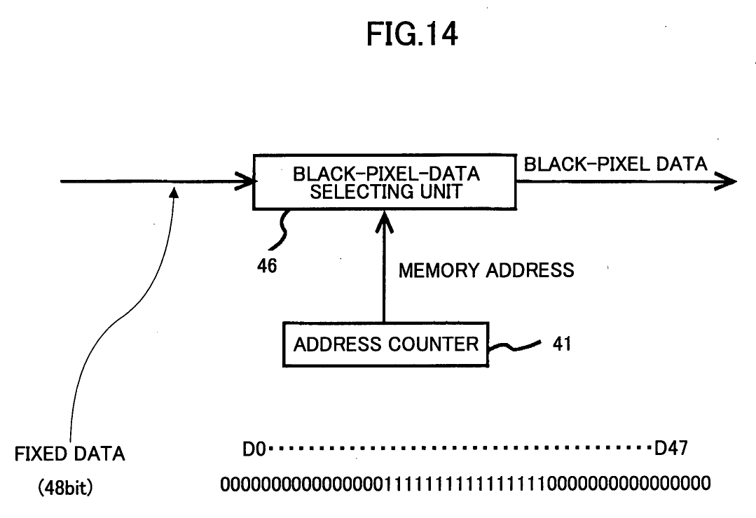

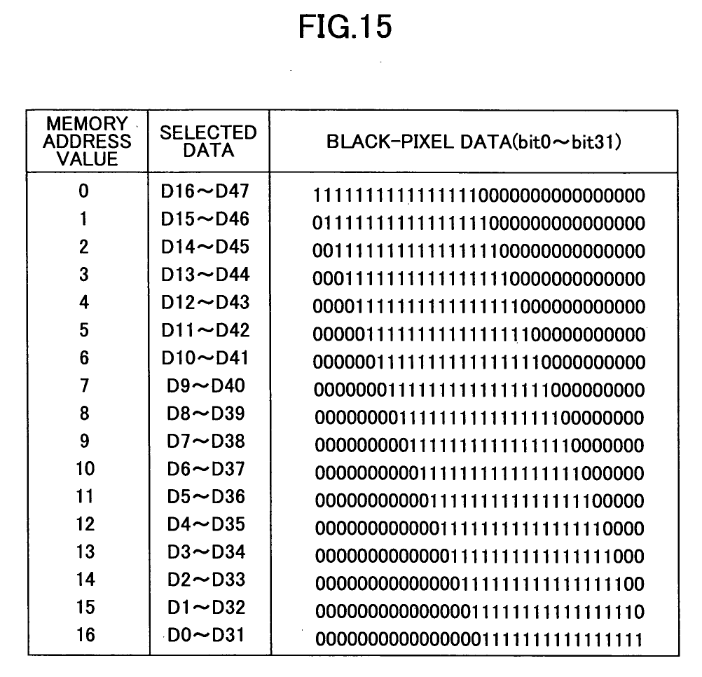

In the above description of the first embodiment, the black-pixel-data holding unit 42 of the modulation-data generating unit 11 has the data table as shown in FIG. 8. Provision may alternatively be made as shown in FIG. 14 such that a portion of fixed data is selected according to the memory address value. Specifically, a black-pixel-data selecting unit 46 is provided in place of the black-pixel-data holding unit 42, and the fixed data as shown in FIG. 14 is supplied. The black-pixel-data selecting unit 46 determines a portion to be selected of the fixed data as shown in FIG. 15 in response to the received memory address value, thereby outputting black-pixel data. With this arrangement, a relatively small circuit suffices to output the modulation data.

The pixel-clock and pulse-modulated-signal generating apparatus 10 of the present embodiment may be implemented as an ASIC (application specific integrated circuit), which achieves resource saving.

### Second Embodiment

In the following, a second embodiment of a pixel-clock and pulse-modulated-signal generating apparatus according to the present invention will be described. The pixel-clock and pulse-modulated-signal generating apparatus 10 of this embodiment has the same configuration as the pixel-clock and pulse-modulated-signal generating apparatus 10 of the first embodiment, except for the configuration of the modulation-data generating unit 11. A description of the same elements will be omitted, and the modulation-data generating unit 11 having a different configuration will be described.

<Modulation Data Generating Unit>

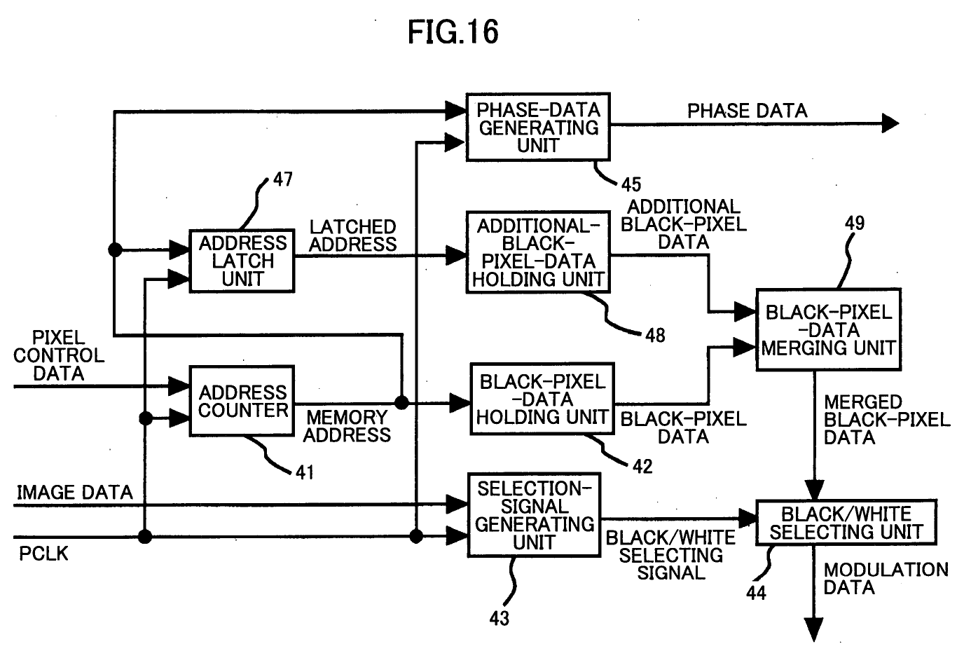

The modulation-data generating unit 11 will now be described by referring to FIG. 16. The modulation-data generating unit 11 includes the address counter 41, the black-pixel-data holding unit 42, the selection-signal generating unit 43, the black/white selecting unit 44, the phase-data generating unit 45, an address latch unit 47, an additional-black-pixel-data holding unit 48, and a black-pixel-data merging unit 49.

The address counter 41 supplies a “memory address” to the black-pixel-data holding unit 42, the phase-data generating unit 45, and the address latch unit 47. The outputting of the memory address is synchronized with the pixel clock.

The address counter 41 changes the value of the memory address in response to the received pixel control data. This is the same as that of the first embodiment, and a description thereof will be omitted. It should be noted that when the memory address is reset or set to “0” or “16”, the address counter 41 initializes the memory address by setting it to “8”.

The address latch unit 47 latches the memory address supplied from the address counter 41, and delays the memory address by one cycle of PCLK for provision to the additional-black-pixel-data holding unit 48. Namely, the address latch unit 47 outputs the memory address value that is provided one PCLK cycle ago.

In the following description, the address output from the address latch unit 47 is referred to as “latched address”.

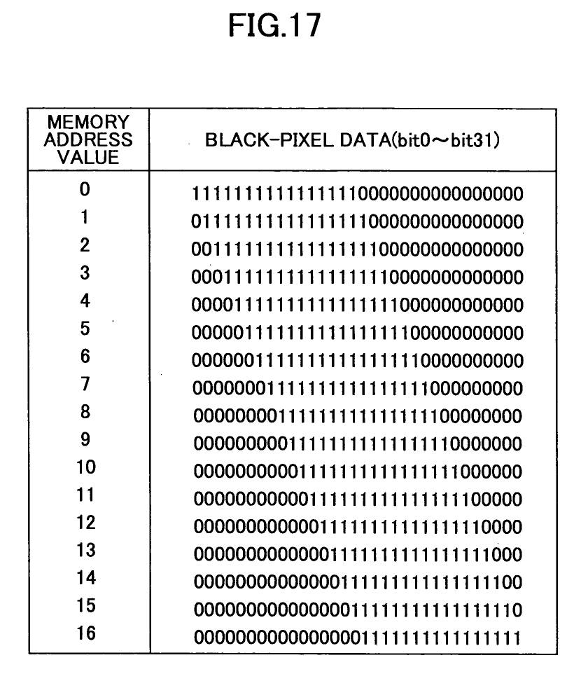

The black-pixel-data holding unit 42 has a data table indicating the relationships between the value of the memory address and the black-pixel data as shown in FIG. 17. In response to the receipt of a memory address, the black-pixel-data holding unit 42 supplies the corresponding black-pixel data to the black-pixel-data merging unit 49.

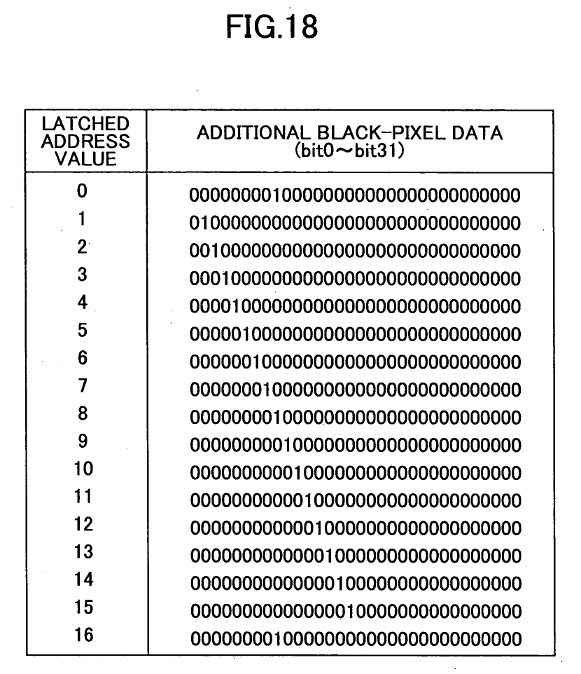

The additional-black-pixel-data holding unit 48 has a data table indicating the relationships between the value of the latched address and the additional black-pixel data as shown in FIG. 18. In response to the receipt of a latched address, the additional-black-pixel-data holding unit 48 supplies the corresponding additional black-pixel data to the black-pixel-data merging unit 49.

The black-pixel-data merging unit 49 performs a bit-by-bit logical sum between the black-pixel data supplied from the black-pixel-data holding unit 42 and the additional black-pixel data supplied from the additional-black-pixel-data holding unit 48, and supplies the obtained logical sum as merged black-pixel data to the black/white selecting unit 44.

The selection-signal generating unit 43 supplies to the black/white selecting unit 44 a “black/white selecting signal” that is the image data delayed by one clock by using the pixel clock.

The black/white selecting unit 44 outputs the merged black-pixel data supplied from the black-pixel-data merging unit 49 as the modulation data if the black/white selecting signal supplied from the selection-signal generating unit 43 is “1”. The black/white selecting unit 44 outputs white-pixel data having all the bits thereof set to “0” (white pixel) as the modulation data if the black/white selecting signal is “0”.

The phase-data generating unit 45 generates and outputs “phase data” in response to the memory address supplied from the address counter 41. This is the same as that of the first embodiment, and a description thereof will be omitted.

<Generation of PM Signal>

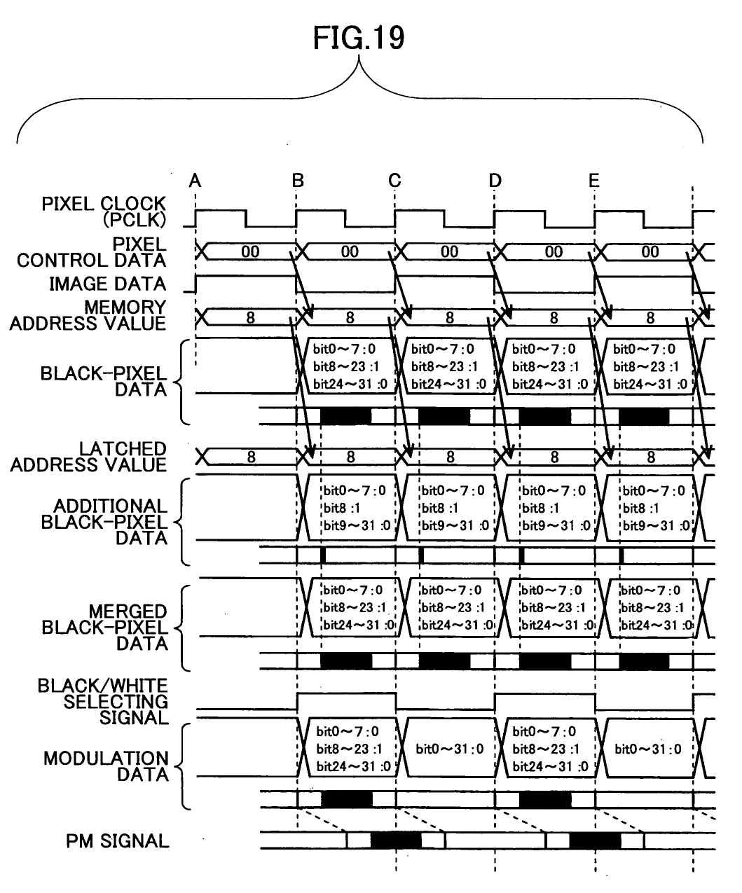

Referring to FIG. 19 through FIG. 24, a description will now be given of the overall operation of the pixel-clock and pulse-modulated-signal generating apparatus 10 of the present embodiment up to the point where the PM signal is generated. In the following disclosure, the term “timing (A through C)” is used to refer to the timing of a rising edge of PCLK.

<Generation of PM Signal (6)>

FIG. 19 is a drawing showing the case in which black-pixel data and white-pixel data are output alternately without displacing the dots. Here, the address counter is set to its initial value “8”.

At the timing A, the pixel control data “00” is given. The image data is “1” indicative of a black pixel.

At timing B, the pixel control data “00” is given, so that the address counter 41 keeps the initial value “8” as the memory address, which is then supplied to the black-pixel-data holding unit 42. The black-pixel-data holding unit 42 outputs to, the black-pixel-data merging unit 49, black-pixel data in which 16 bits “bit8 through bit23” are set to “1” as the black-pixel data corresponding to the memory address “8”.

The address latch unit 47 latches the memory address value “8” provided at the timing A, and supplies this as the latched address to the additional-black-pixel-data holding unit 48 at the timing B. The additional-black-pixel-data holding unit 48 outputs to, the black-pixel-data merging unit 49, additional black-pixel data in which 1 bit “bit8” is set to “1” as the additional black-pixel data corresponding to the memory address “8”.

The black-pixel-data merging unit 49 performs a logical sum between the black-pixel data having 16 bits bit8 through bit23 thereof set to “1” and the additional black-pixel data having 1 bit bit8 thereof set to “1”, and supplies the black-pixel data having 16 bits bit8 through bit23 thereof set to “1” to the black/white selecting unit 44 as merged black-pixel data.

Since the black/white selecting signal is the image data delayed by one clock by using the pixel clock PCLK, the black/white selecting signal becomes “1” at the timing B. Since the black/white selecting signal is “1”, the black/white selecting unit 44 supplies the merged black-pixel data provided from the black-pixel-data merging unit 49 to the serial modulated-signal generating unit 14 as the modulation data. The serial modulated-signal generating unit 14 generates the PM signal from the modulation data for serial output.

Since the black/white selecting signal is “0” at timing C (i.e., the image data is “0” at the timing B), the black/white selecting unit 44 supplies the white-pixel data having all the bits thereof set to “0” to the serial modulated-signal generating unit 14 as the modulation data. The serial modulated-signal generating unit 14 generates the PM signal from the modulation data for serial output.

As described above, the pixel-clock and pulse-modulated-signal generating apparatus 10 of the present embodiment has the modulation-data generating unit 11 that generates the modulation data in response to the image data (black pixels/white pixels), thereby being able to generate the PM signal responsive to the received image data.

<Generation of PM Signal (7)>

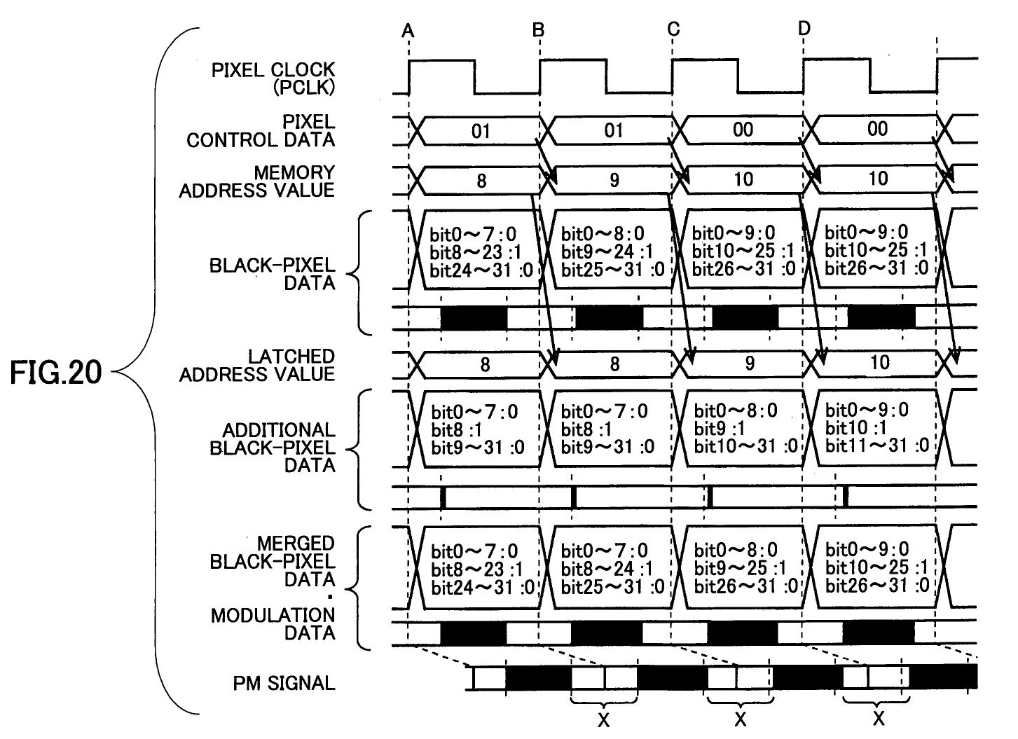

In the following, the operation by which a dot is shifted to the right (displaced to the right) will be described. FIG. 20 is a drawing showing the case in which dots are shifted to the right by 1/32 of a pixel. In the following, the image data is assumed-to be all-black-pixel data for the sake of convenience of explanation.

At the timing A, the pixel control data “01” is given. Here, the memory address is set to its initial value “8”. The address counter 41 counts up the memory address at the timing B, and supplies “9” as the memory address value to the black-pixel-data holding unit 42. The black-pixel-data holding unit 42 outputs to, the black-pixel-data merging unit 49, black-pixel data in which 16 bits “bit9 through bit24” are set to “1” as the black-pixel data corresponding to the memory address “9”.

The address latch unit 47 latches the memory address value “8” provided at the timing A, and supplies this as the latched address to the additional-black-pixel-data holding unit 48 at the timing B. The additional-black-pixel-data holding unit 48 outputs to, the black-pixel-data merging unit 49, additional black-pixel data in which 1 bit “bit8” is set to “1” as the additional black-pixel data corresponding to the latched address “8”.

The black-pixel-data merging unit 49 performs a logical sum between the black-pixel data having 16 bits bit9 through bit24 thereof set to “1” and the additional black-pixel data having 1 bit bit8 thereof set to “1”, and supplies the black-pixel data having 17 bits bit8 through bit24 thereof set to “1” to the black/white selecting unit 44 as merged black-pixel data. The black/white selecting unit 44 supplies this merged black-pixel data provided from the black-pixel-data merging unit 49 as the modulation data to the serial modulated-signal generating unit 14 (the explanation of black/white selection is omitted since the data is all-black-pixel data in this example). The serial modulated-signal generating unit 14 generates the PM signal from the modulation data for serial output.

The pixel control data is also “01” at timing B, so that the address counter 41 counts up the memory address also at the timing C, and supplies “10” as the memory address value to the black-pixel-data holding unit 42. The black-pixel-data holding unit 42 outputs to, the black-pixel-data merging unit 49, black-pixel data in which 16 bits “bit10 through bit25” are set to “1” as the black-pixel data corresponding to “10”.

The address latch unit 47 latches the memory address value “9” provided at the timing B, and supplies this as the latched address to the additional-black-pixel-data holding unit 48 at the timing C. The additional-black-pixel-data holding unit 48 outputs to, the black-pixel-data merging unit 49, additional black-pixel data in which 1 bit “bit9” is set to “1” as the additional black-pixel data corresponding to the latched address “9”.

The black-pixel-data merging unit 49 performs a logical sum between the black-pixel data having 16 bits bit10 through bit25 thereof set to “1” and the additional black-pixel data having 1 bit bit9 thereof set to “1”, and supplies the black-pixel data having 17 bits bit9 through bit25 thereof set to “1” to the black/white selecting unit 44 as merged black-pixel data. The black/white selecting unit 44 supplies this merged black-pixel data provided from the black-pixel-data merging unit 49 as the modulation data to the serial modulated-signal generating unit 14. The serial modulated-signal generating unit 14 generates the PM signal from the modulation data for serial output.

Compared with the merged black-pixel data at the timing A (memory address value=latched address value=“8), the merged black-pixel data at the timing B (memory address value=“9”; latched address value=“8) has one additional black bit at its end on the right, having a total of 17 black bits. Further, both the merged black-pixel data at the timing B and the merged black-pixel data at the timing C have 17 black bits, with one bit displacement to the right with respect to the merged black-pixel data at the timing C. With such dot position adjustment, the interval between the black bits as indicate by “X” in FIG. 20 is kept constant (i.e., kept to a 16-bit width all the time).

In the first embodiment, the width corresponding to “X” is 17 bits, with a one additional bit (see FIG. 10). Such change in the interval between black bits causes image degradation.

As described above, the pixel-clock and pulse-modulated-signal generating apparatus 10 of the present embodiment can keep constant the interval between black bits generated when the timing of dot printing is delayed by an increment of 1/32 of a pixel, i.e., when the dots are shifted to the right by an increment of 1/32 of a pixel. This makes it possible to suppress image degradation caused by a change in the interval between black bits.

<Generation of PM Signal (8)>

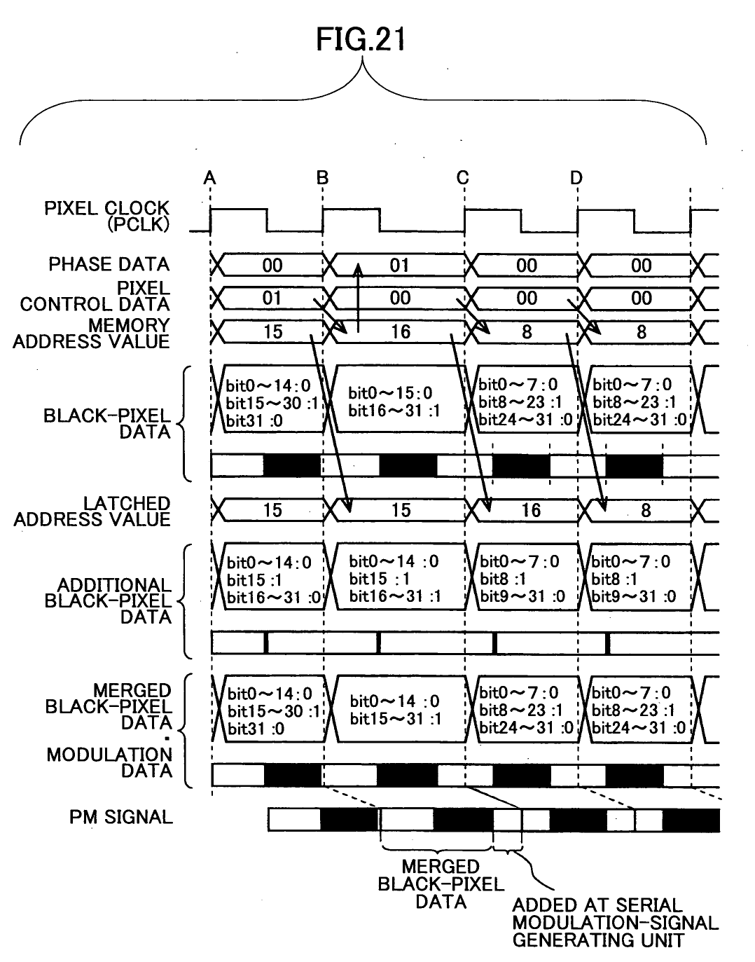

Referring to FIG. 21, a description will now be given of the case in which the memory address value becomes “16” in the generation of the PM signal (7) described above. In the following, the image data is assumed to be all-black-pixel data for the sake of convenience of explanation.

At the timing A, the pixel control data “01” is given. At this timing, the memory address value is “15”. The address counter 41 counts up the memory address at the timing B, and supplies “16” as the memory address value to the black-pixel-data holding unit 42. The black-pixel-data holding unit 42 outputs to, the black-pixel-data merging unit 49, black-pixel data in which 16 bits “bit16 through bit31” are set to “1” as the black-pixel data corresponding to the memory address value “16”.

The memory address value is also supplied to the phase-data generating unit 45. Upon receiving the memory address value “16”, the phase-data generating unit 45 generates phase data “01”, and supplies the generated phase data to the pixel-clock generating unit 13. Upon receiving the phase data “01”, the pixel-clock generating unit 13 elongates the pixel clock by 2/8 of a cycle at the timing B, and outputs the elongated pixel clock.

The address latch unit 47 latches the memory address value “15” provided at the timing A, and supplies this as the latched address to the additional-black-pixel-data holding unit 48 at the timing B. The additional-black-pixel-data holding unit 48 outputs to, the black-pixel-data merging unit 49, additional black-pixel data in which 1 bit “bit15” is set to “1” as the additional black-pixel data corresponding to the latched address “15”.

The black-pixel-data merging unit 49 performs a logical sum between the black-pixel data having 16 bits bit16 through bit31 thereof set to “1” and the additional black-pixel data having 1 bit bit15 thereof set to “1”, and supplies the black-pixel data having 17 bits bit15 through bit31 thereof set to “1” to the black/white selecting unit 44 as merged black-pixel data. The black/white selecting unit 44 supplies this merged black-pixel data provided from the black-pixel-data merging unit 49 as the modulation data to the serial modulated-signal generating unit 14 (the explanation of black/white selection is omitted since the data is all-black-pixel data in this example).

Since the pixel clock is shifted (elongated) at the timing B, the serial modulated-signal generating unit 14 adds “0” data equal in number to 8 bits to generate and output the PM signal.

At the next timing (i.e., timing C), the address counter 41 initializes the memory address value from “16” to “8” to output “8”, and the black-pixel-data holding unit 42 outputs black-pixel data in which 16 bits “bit8 through bit23” are set to “1” as the black-pixel data corresponding to “8”.

The address latch unit 47 latches the memory address value “16” provided at the timing B, and supplies this as the latched address to the additional-black-pixel-data holding unit 48 at the timing C. The additional-black-pixel-data holding unit 48 outputs to, the black-pixel-data merging unit 49, additional black-pixel data in which 1 bit “bit8” is set to “1” as the additional black-pixel data corresponding to the latched address “8”.

The black-pixel-data merging unit 49 performs a logical sum between the black-pixel data having 16 bits bit8 through bit23 thereof set to “1” and the additional black-pixel data having 1 bit bit8 thereof set to “1”, and supplies the black-pixel data having 16 bits bit8 through bit23 thereof set to “1” to the black/white selecting unit 44 as merged black-pixel data. The black/white selecting unit 44 supplies this merged black-pixel data provided from the black-pixel-data merging unit 49 as the modulation data to the serial modulated-signal generating unit 14 (the explanation of black/white selection is omitted since the data is all-black-pixel data in this example).

In FIG. 21 also, the intervals between black bits are kept constant (i.e., kept to a 16-bit width all the time).

As described above, the pixel-clock and pulse-modulated-signal generating apparatus 10 of the present embodiment returns the memory address value to its initial value when the memory address value becomes “16”. Accordingly, even after the memory address value becomes “16”, it is possible to delay the timing of dot printing by 1/32 of a pixel, i.e., to shift a dot to the right in units of 1/32 of a pixel, while keeping constant the intervals between black bits.

<Generation of PM Signal (9)>

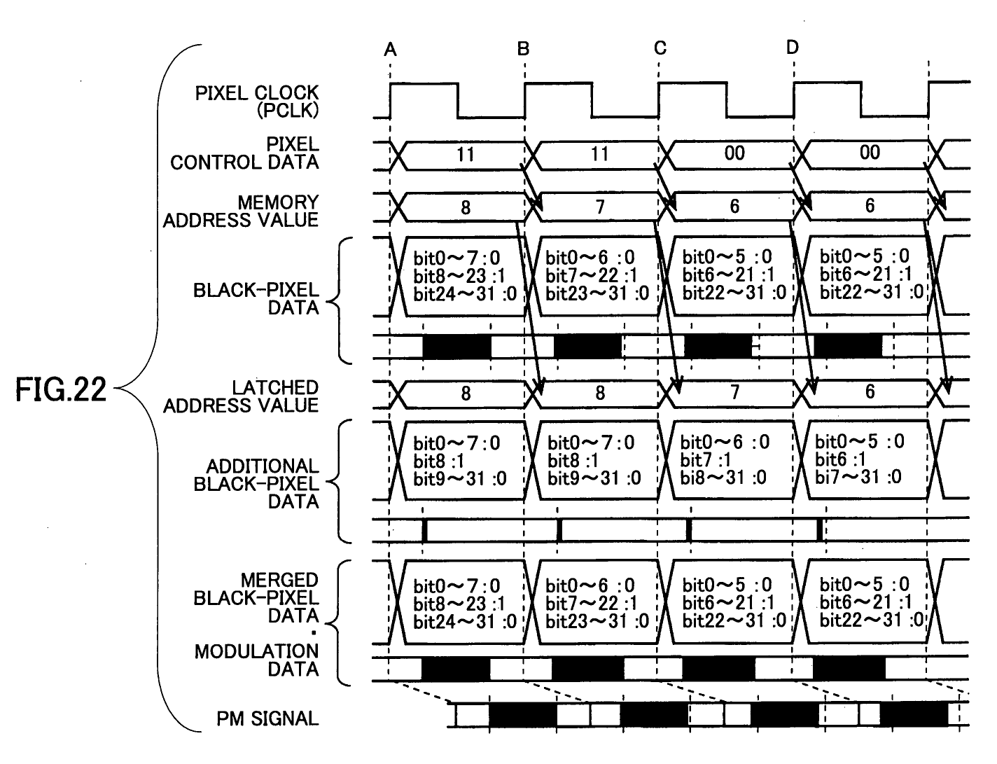

In the following, the operation by which a dot is shifted to the left (displaced to the left) will be described. FIG. 22 is a drawing showing the case in which dots are shifted to the left by 1/32 of a pixel. In the following, the image data is assumed to be all-black-pixel data for the sake of convenience of explanation.

At the timing A, the pixel control data “11” is given. Here, the memory address is set to its initial value “8”. The address counter 41 counts down the memory address at the timing B, and supplies “7” as the memory address value to the black-pixel-data holding unit 42. The black-pixel-data holding unit 42 outputs to, the black-pixel-data merging unit 49, black-pixel data in which 16 bits “bit7 through bit22” are set to “1” as the black-pixel data corresponding to the memory address value “7”.

The address latch unit 47 latches the memory address value “8” provided at the timing A, and supplies this as the latched address to the additional-black-pixel-data holding unit 48 at the timing B. The additional-black-pixel-data holding unit 48 outputs to, the black-pixel-data merging unit 49, additional black-pixel data in which 1 bit “bit8” is set to “1” as the additional black-pixel data corresponding to the latched address value “8”.

The black-pixel-data merging unit 49 performs a logical sum between the black-pixel data having 16 bits bit7 through bit22 thereof set to “1” and the additional black-pixel data having 1 bit bit8 thereof set to “1”, and supplies the black-pixel data having 16 bits bit7 through bit22 thereof set to “1” to the black/white selecting unit 44 as merged black-pixel data. The black/white selecting unit 44 supplies this merged black-pixel data provided from the black-pixel-data merging unit 49 as the modulation data to the serial modulated-signal generating unit 14 (the explanation of black/white selection is omitted since the data is all-black-pixel data in this example). The serial modulated-signal generating unit 14 generates the PM signal from the modulation data for serial output.

The pixel control data is also “11” at timing B, so that the address counter 41 counts down the memory address also at the timing C, and supplies “6” as the memory address value to the black-pixel-data holding unit 42. The black-pixel-data holding unit 42 outputs to, the black-pixel-data merging unit 49, black-pixel data in which 16 bits “bit6 through bit21” are set to “1” as the black-pixel data corresponding to the memory address value “6”.

The address latch unit 47 latches the memory address value “7” provided at the timing B, and supplies this as the latched address to the additional-black-pixel-data holding unit 48 at the timing C. The additional-black-pixel-data holding unit 48 outputs to, the black-pixel-data merging unit 49, additional black-pixel data in which 1 bit “bit7” is set to “1” as the additional black-pixel data corresponding to the latched address value “7”.

The black-pixel-data merging unit 49 performs a logical sum between the black-pixel data having 16 bits bit6 through bit21 thereof set to “1” and the additional black-pixel data having 1 bit bit7 thereof set to “1”, and supplies the black-pixel data having 16 bits bit6 through bit21 thereof set to “1” to the black/white selecting unit 44 as merged black-pixel data. The black/white selecting unit 44 supplies this merged black-pixel data provided from the black-pixel-data merging unit 49 as the modulation data to the serial modulated-signal generating unit 14. The serial modulated-signal generating unit 14 generates the PM signal from the modulation data for serial output.

As described above, the pixel-clock and pulse-modulated-signal generating apparatus 10 of the present embodiment has the modulation-data generating unit 11 that can generate the modulation data in which “1” bits are advanced by an increment of 1/32 of a pixel, thereby being able to advance the generated PM signal by an increment of 1/32 of a pixel. Accordingly, it is possible to advance the timing of dot printing by 1/32 of a pixel, i.e., to shift a dot to the left in units of 1/32 of a pixel.

<Generation of PM Signal (10)>

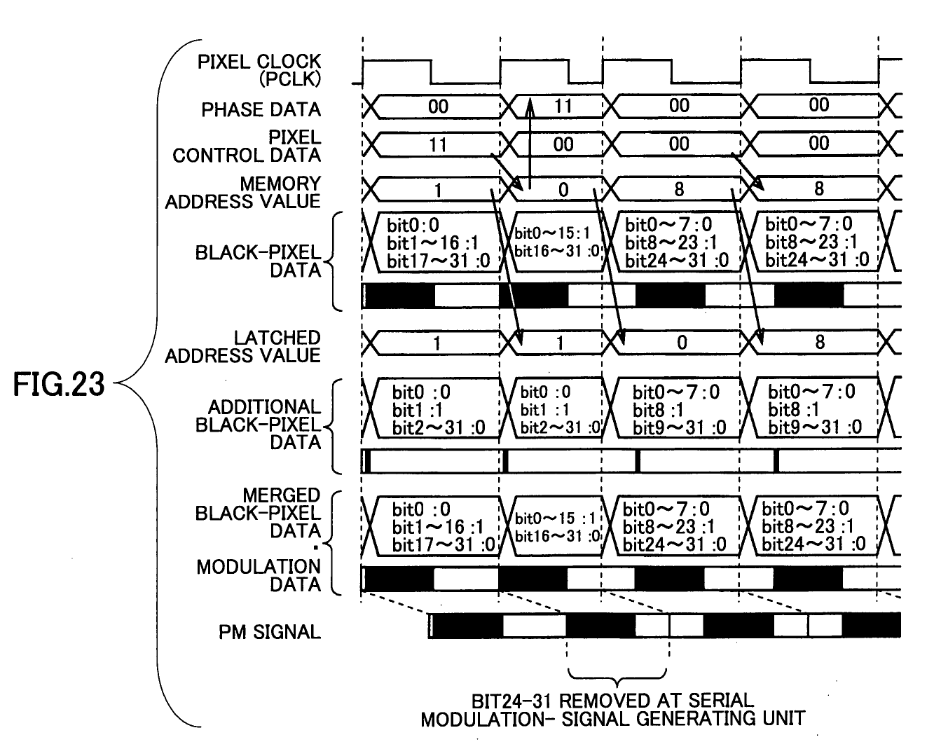

Referring to FIG. 23, a description will now be given of the case in which the memory address value becomes “0” in the generation of the PM signal (9) described above. In the following, the image data is assumed to be all-black-pixel data for the sake of convenience of explanation.

At the timing A, the pixel control data “11” is given. At this timing, the memory address value is “1”. The address counter 41 counts down the memory address at the timing B, and supplies “0” as the memory address value to the black-pixel-data holding unit 42. The black-pixel-data holding unit 42 outputs to, the black-pixel-data merging unit 49, black-pixel data in which 16 bits “bit0 through bit15” are set to “1” as the black-pixel data corresponding to the memory address value “0”.

The memory address value is also supplied to the phase-data generating unit 45. Upon receiving the memory address value “0”, the phase-data generating unit 45 generates phase data “11”, and supplies the generated phase data to the pixel-clock generating unit 13. Upon receiving the phase data “11”, the pixel-clock generating unit 13 shortens the pixel clock by 2/8 of a cycle at the timing B, and outputs the shortened pixel clock.

The address latch unit 47 latches the memory address value “1” provided at the timing A, and supplies this as the latched address to the additional-black-pixel-data holding unit 48 at the timing B. The additional-black-pixel-data holding unit 48 outputs to, the black-pixel-data merging unit 49, additional black-pixel data in which 1 bit “bit1” is set to “1” as the additional black-pixel data corresponding to the latched address value “1”.

The black-pixel-data merging unit 49 performs a logical sum between the black-pixel data having 16 bits bit0 through bit15 thereof set to “1” and the additional black-pixel data having 1 bit bit1 thereof set to “1”, and supplies the black-pixel data having 16 bits bit0 through bit15 thereof set to “1” to the black/white selecting unit 44 as merged black-pixel data. The black/white selecting unit 44 supplies this merged black-pixel data provided from the black-pixel-data merging unit 49 as the modulation data to the serial modulated-signal generating unit 14 (the explanation of black/white selection is omitted since the data is all-black-pixel data in this example).

Since the pixel clock is shifted (shortened) at the timing B, the serial modulated-signal generating unit 14 removes 8 bits (bit24 through bit31) (equal in number to 2/8 of a PCLK cycle) to generate and output the PM signal.

At the next timing (i.e., timing C), the address counter 41 initializes the memory address value from “0” to “8” to output “8”, and the black-pixel-data holding unit 42 outputs black-pixel data in which 16 bits “bit8 through bit23” are set to “1” as the black-pixel data corresponding to the memory address value “8”.

The address latch unit 47 latches the memory address value “0” provided at the timing B, and supplies this as the latched address to the additional-black-pixel-data holding unit 48 at the timing C. The additional-black-pixel-data holding unit 48 outputs to, the black-pixel-data merging unit 49, additional black-pixel data in which 1 bit “bit8” is set to “1” as the additional black-pixel data corresponding to the latched address “8”.

The black-pixel-data merging unit 49 performs a logical sum between the black-pixel data having 16 bits bit8 through bit23 thereof set to “1” and the additional black-pixel data having 1 bit bit8 thereof set to “1”, and supplies the black-pixel data having 16 bits bit8 through bit23 thereof set to “1” to the black/white selecting unit 44 as merged black-pixel data. The black/white selecting unit 44 supplies this merged black-pixel data provided from the black-pixel-data merging unit 49 as the modulation data to the serial modulated-signal generating unit 14.

As described above, the pixel-clock and pulse-modulated-signal generating apparatus 10 of the present embodiment returns the memory address value to its initial value when the memory address value becomes “0”. Accordingly, even after the memory address value becomes “0”, it is possible to advance the timing of dot printing by 1/32 of a pixel, i.e., to shift a dot to the left in units of 1/32 of a pixel.

### Advantage of Second Embodiment

As described above, the pixel-clock and pulse-modulated-signal generating apparatus of the present embodiment can displace the PM signal by an increment of 1/32 of a pixel. Accordingly, it is possible to displace the timing of dot printing by an increment of 1/32 of a pixel, thereby performing the fine adjustment and control of dot position. Further, a plurality of high-frequency clocks having respective, different phases are used to change the timing of pixel printing with the precision corresponding to 1/32 of a pixel, which is different from the use of a super-high-frequency clock corresponding to 1/32 of a pixel. This achieves power conservation. Further, the intervals between black bits can be kept constant when the dots are shifted to the right.

### Variation of Second Embodiment

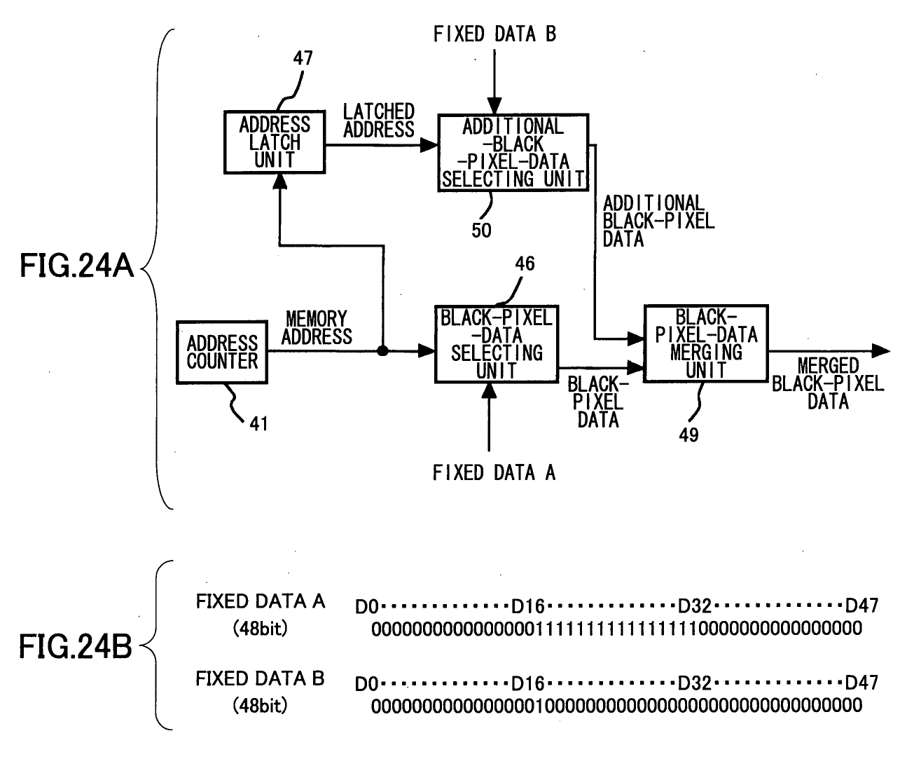

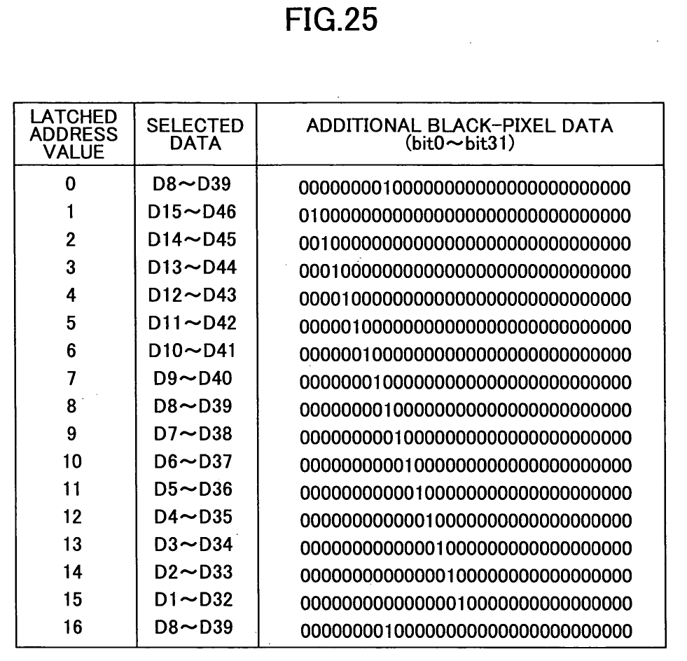

In the above description of the second embodiment, the black-pixel-data holding unit 42 has the data table as shown in FIG. 17, and the additional-black-pixel-data holding unit 48 has the data table as shown in FIG. 18. Provision may alternatively be made as shown in FIGS. 24A and 24B such that a portion of fixed data A and a portion of fixed data B are selected according to the memory address value and the latched address value, respectively. Specifically, the black-pixel-data selecting unit 46 is provided in place of the black-pixel-data holding unit 42, and an additional-black-pixel-data selecting unit 50 is provided in place of the additional-black-pixel-data holding unit 48, with the fixed data A and fixed data B as shown in FIG. 24B being supplied. The black-pixel-data selecting unit 46 determines a portion to be selected of the fixed data A as shown in FIG. 15 in response to the received memory address value, thereby outputting black-pixel data. The additional-black-pixel-data selecting unit 50 determines a portion to be selected of the fixed data B in response to the received latched address value, thereby outputting additional black-pixel data. With this arrangement, a relatively small circuit suffices to output the modulation data.

The pixel-clock and pulse-modulated-signal generating apparatus 10 of the present embodiment may be implemented as an ASIC, which achieves resource saving.

### Third Embodiment/Optical Scan Apparatus

In the following, a third embodiment of the present invention will be described. This embodiment is directed to an optical scan apparatus on which the pixel-clock and pulse-modulated-signal generating apparatus of the first embodiment or the pixel-clock and pulse-modulated-signal generating apparatus of the second embodiment is mounted.

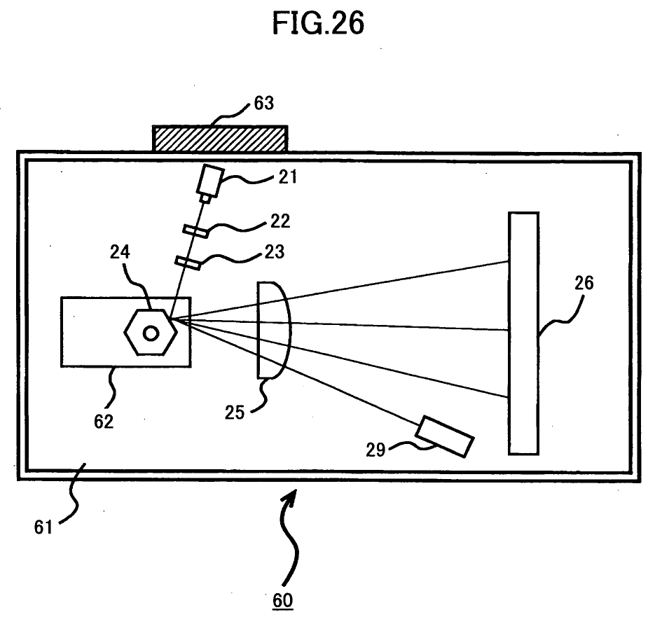

FIG. 26 is a drawing showing the configuration of an optical scan apparatus 60. A description will be omitted of the same elements as those shown in FIG. 1.

The optical scan apparatus 60 includes the semiconductor laser 21, the collimator lens 22, the cylinder lens 23, an optical deflector 62, the fθ lens 25, the mirror 26, and a photo detector 29, which are mounted on an optical housing 61. A printed circuit board 63 having the laser driving unit 32 and the pixel-clock and pulse-modulated-signal generating apparatus 10 of the present invention implemented thereon is attached to the side wall of the optical housing 61 behind the semiconductor laser 21.

The optical beam (laser beam) emitted by the semiconductor laser 21 passes through the collimator lens 22 and the cylinder lens 23 to be deflected and scanned by the polygon mirror 24 of the optical deflector 62. The deflected and scanned optical beam passes through the fθ lens 25, and is reflected by the mirror 26.

The semiconductor laser 21 is driven and controlled by the printed circuit board 63 having the pixel-clock and pulse-modulated-signal generating apparatus 10 of the previous embodiments implemented thereon. Accordingly, as previously described, it is possible to displace the PM signal by an increment of 1/32 of a pixel, thereby performing the fine adjustment and control of dot position in units of 1/32 of a pixel. Further, a plurality of high-frequency clocks having respective, different phases are used to change the timing of pixel printing with the precision corresponding to 1/32 of a pixel, which is different from the use of a super-high-frequency clock corresponding to 1/32 of a pixel. This achieves power conservation.

### Fourth Embodiment/Image Forming Apparatus

In the following, a fourth embodiment of the present invention will be described. This embodiment is directed to an image forming apparatus having the optical scan apparatus 60 of the third embodiment.

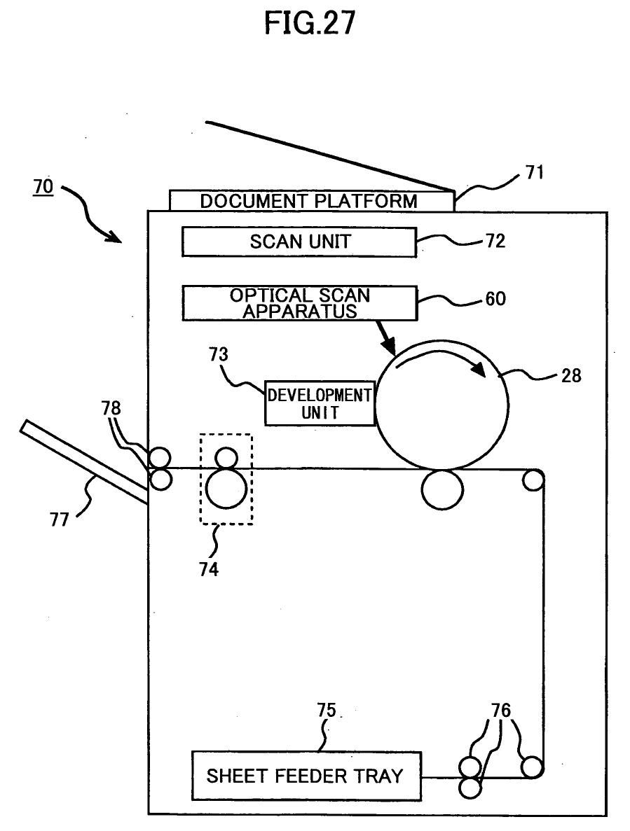

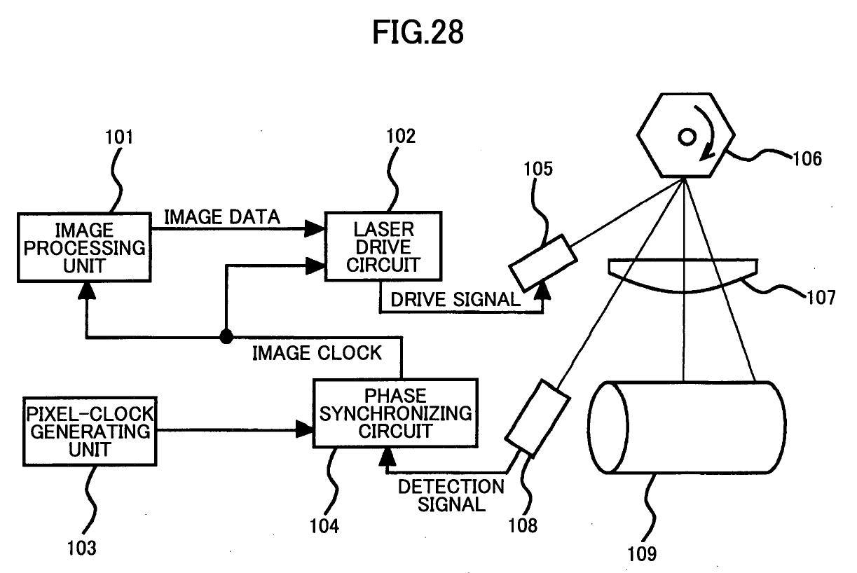

FIG. 27 is a drawing showing the configuration of an image forming apparatus 70. The image forming apparatus 70 includes a document platform 71, a scan unit 72, the optical scan apparatus 60, a development unit 73, the photoconductive body 28, a fusing unit 74, a sheet feeder tray 75, sheet feeder rollers 76, a catch tray 77, and sheet discharging rollers 78.

The scan unit 72 scans the image data of a document placed on the document platform 71, and sends the scanned image data as an image signal to the optical scan apparatus 60. The optical scan apparatus 60 emits an optical beam based on the image signal so as to form an electrostatic latent image on the photoconductive body 28. The development unit 73 develops the electrostatic latent image on the photoconductive body 28 to form a toner image. The toner image is then transferred onto a sheet that has been conveyed by the sheet feeder rollers 76 from the sheet feeder tray 75. The fusing unit 74 applies heat to fuse the toner image with the sheet. The sheet having the fused toner image thereon is discharged onto the catch tray 77 via the sheet discharging rollers 78.

The image forming apparatus 70 of the present embodiment employs the optical scan apparatus of the third embodiment as the optical scan apparatus 60. Accordingly, as previously described, it is possible to displace the PM signal by an increment of 1/32 of a pixel, thereby performing the fine adjustment and control of dot position in units of 1/32 of a pixel. Further, a plurality of high-frequency clocks having respective, different phases are used to change the timing of pixel printing with the precision corresponding to 1/32 of a pixel, which is different from the use of a super-high-frequency clock corresponding to 1/32 of a pixel. This achieves power conservation.

Further, the present invention is not limited to these embodiments, but various variations and modifications may be made without departing from the scope of the present invention.

The present application is based on Japanese priority application No. 2005-223939 filed on Aug. 2, 2005, with the Japanese Patent Office, the entire contents of which are hereby incorporated by reference.

What is claimed is:

1. An apparatus for generating a pulse modulated signal having pulses corresponding to binary values of pixels of image data, comprising:
a modulation-data generating unit configured to generate modulation data in response to pixel control data and the image data, the modulation data including a predetermined number of bits for a pixel of the image data, wherein consecutive bits having bit positions responsive to the pixel control data in a line of the predetermined number of bits have a value responsive to a binary value of the pixel; and
a modulated-signal generating unit configured to generate a pulse modulated signal in response to the modulation data.

2. The apparatus as claimed in claim 1, wherein the modulation-data generating unit includes a pixel-data holding unit configured to store data of the predetermined number of bits separately for each of a plurality of bit patterns, and wherein one of the plurality of bit patterns is selected as the predetermined number of bits for the pixel.

3. The apparatus as claimed in claim 1, wherein the modulation-data generating unit is configured to select a portion of fixed-bit-pattern data in response to the pixel control data, the portion selected from the fixed-bit pattern data being the predetermined number of bits for the pixel.

4. The apparatus as claimed in claim 1, wherein the modulation-data generating unit includes:
a first pixel-data generating unit configured to generate first pixel data having the predetermined number of bits, the first pixel data including a first fixed number of bits whose bit positions are responsive to current pixel control data;
a second pixel-data generating unit configured to generate second pixel data having the predetermined number of bits, the second pixel data including a second fixed number of bits whose bit positions are responsive to preceding pixel control data; and
a pixel-data merging unit configured to merge the first pixel data and the second pixel data so as to generate the modulation data.

5. The apparatus as claimed in claim 4, wherein the first pixel-data generating unit is configured to store data of the predetermined number of bits separately for each of a plurality of bit patterns, and wherein one of the plurality of bit patterns is selected as the first pixel data.

6. The apparatus as claimed in claim 4, wherein the second pixel-data generating unit is configured to store data of the predetermined number of bits separately for each of a plurality of bit patterns, and wherein one of the plurality of bit patterns is selected as the second pixel data.

7. The apparatus as claimed in claim 4, wherein the first pixel-data generating unit is configured to select a portion of fixed-bit-pattern data in response to the current pixel control data, the portion selected from the fixed-bit pattern data being the first pixel data.

8. The apparatus as claimed in claim 4, wherein the second pixel-data generating unit is configured to select a portion of fixed-bit-pattern data in response to the previous pixel control data, the portion selected from the fixed-bit pattern data being the second pixel data.

9. The apparatus as claimed in claim 1, further comprising a high-frequency-clock generating unit configured to generate a plurality of high-frequency clock signals with respective, different phases, the high-frequency clock signals having a frequency higher than a pixel clock with which the pulse-modulated signal is synchronized.

10. The apparatus as claimed in claim 1, wherein the modulation-data generating unit includes a circuit configured to indicate the bit positions of the consecutive bits, the circuit having a state thereof changed in response to the pixel control data.

11. The apparatus as claimed in claim 10, wherein the predetermined number is temporarily changed when the circuit is reset.

12. An optical scan apparatus, comprising the apparatus of claim 1.

13. An image forming apparatus, comprising the optical scan apparatus of claim 12.
